(19) United States
(12) Patent Application Publication
(10) Pub. No.: US 2002/0186412 A1
(43) Pub. Date: Dec. 12, 2002

(54) Image data storing system and method, image obtaining apparatus, image data storage apparatus, mobile terminal, and computer-readable medium in which a related program is recorded

(75) Inventor: Kimitaka Murashita, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 10/079,433

(22) Filed: Feb. 22, 2002

(30) Foreign Application Priority Data
May 18, 2001 (JP) 2001-149814

(51) Int. Cl. B41B 1/00; G06F 15/00

(52) U.S. Cl. 358/1.16; 358/1.18

(57) ABSTRACT

A system is provided which facilitates management and classification of image data obtained by a digital camera. The system includes an image obtaining apparatus, a storage means for storing the image data obtained by the image obtaining apparatus, a means for obtaining site information representing a site at which the image data has been obtained, a means for obtaining subject information identifying the subject of the image data, and a means for labeling the image data, which is to be stored into the storage means, with both the site information and the subject information. The invention is applicable to a system which stores digital image data obtained by a digital still camera.

### BACKGROUND OF THE INVENTION

1. Field of the Invention

The present invention relates to a system and method for storing digital image data obtained by, for example, a digital still camera (hereinafter simply called a digital camera). The invention also relates to equipment used in the system and to recording media in which the system-related programs are recorded. In particular, the invention relates to a technique for providing users with information effective for managing and classifying the image data and with any other useful information.

2. Description of the Related Art

With recent widespread use of digital cameras, digital images have been becoming increasingly popular among users. A digital camera obtains an image of a subject with a CCD (Charge Coupled Device), and the reflected light the CCD receives is converted into digital data. Recent digital images are normally in full color, and in such a full color image, 8 bits are used to represent each of the primary colors (Red, Green, and Blue: RGB). Every pixel of a full color image thus has a size of 3 bytes, and a single full color image obtained by a digital camera of 3,000,000-pixel resolution has a file size of as much as 9 MB.

In view of this, image data obtained by a digital camera is normally stored in a JPEG (Joint Photographic Experts Group): JPEG is an international standard for still picture image compression method developed in cooperation between the ISO (International Organization for Standardization) and the CCITT {Consultative Committee for International Telegraph and Telephone; the CCITT is called the ITU-T (International Telecommunications Union-Telecommunication Standardization Sector), now}.

The JPEG uses ADCT (Adaptive Discrete Cosine Transform), linear quantization, and variable-length coding to remove redundancies, thereby compressing the size of image data. The compression ratio in JPEG depends upon what a subject of image data is, yielding a ratio of 10:1 or lower for landscape images, and a ratio of 20:1 or lower for portrait images. Thus, a landscape image obtained by a digital camera of 3,000,000-pixel resolution has a file size of 900 KB or so; and a portrait image, a file size of 450 KB or so.

TIFF (Tagged Image File Format) is another format commonly used for storing image data obtained by digital cameras. Some of the digital cameras that are now being distributed in the market are allowed to use these formats selectively. JPEG should be employed when a picture image is to be compressed, while TIFF should be employed when a picture image is not to be compressed. JPEG is advantageous in that it realizes a high compression ratio resulting from removal of redundancies in image data. The removal, however, would cause deteriorated image quality, such as block noises, mosquito noises, and pseudo-contours. If such image degradation is not acceptable, users should select TIFF, which is free from any image compression.

A JPEG image file and a TIFF image file, as shown in FIG. 26, have not only a storage area for storing image data itself but also another area (header) for storing various items of information relating to the image data. Such a header of image data normally stores a file name, a file size, the date and time the image data was generated, a device name (camera name) that generated the image data, an image data pointer, and others. By referring to the header, users are able to check when the image data was obtained. In conventional cameras, the date and time a picture was taken (hereinafter also called the date and time of photographing) is printed in the corner of the picture, thereby making it possible for a user to recognize when the picture was taken. In digital cameras, however, since information stored in the header of image data is stored separately from the image data itself, it is impossible for a user, even if the image data is merely shown on a display, to know the date and time of photographing, unless the user refers to the header.

Digital cameras normally operate in the following way. A user takes a picture image of a subject with a digital camera in the same way as when using an existing film-type camera (hereinafter called a conventional camera). The image data thus obtained is stored not in a film but in a non-volatile memory medium (CompactFlash™, SmartMedia™, and so on) built in the digital camera. Because such a memory medium has only a small amount of capacity and is more expensive than a film, a user has to move the image data into some storage medium (for example, a hard disc drive (HDD) of a PC) having a great amount of capacity, when necessary.

In comparison with conventional cameras, the above-mentioned digital cameras and image data obtained by such digital cameras guarantee the following features:

(a1) it is easy to process image data;

(a2) it is easy to delete image data;

(a3) it is possible to obtain a great amount of image data with use of a memory having a great amount of capacity;

(a4) it is easy to duplicate and distribute image data;

(a5) picture images will never deteriorate with time.

(a6) a memory medium built in a digital camera can be used repetitively;

(a7) image data stored in the memory medium can be browsed on a personal computer (hereinafter also called a PC), so that only the required image data can be selectively printed out; and

(a8) since image data that is not required can be deleted immediately after being obtained, it is possible for a user to keep only the image data he wishes to.

With the widespread use of information communications devices in Japan, positioning services have been started in which the current position of a user is provided by radio: for example, GPS (Global Positioning System) and a PHS (Personal Handyphone System) positioning services such as mopera™ of NTT Docomo, Inc.

Here, GPS is a satellite-based positioning system. Using an information communications device, a user receives latitude and longitude information sent out from GPS satellites, thereby being notified of his current position on the earth.

Referring now to FIG. 27, in a positioning service, such as mopera™ of NTT Docomo, Inc., a user makes a contents request from mobile terminal 200, which he carries, to network server 203 via base station 201 and communications network 202. Upon receipt of the contents request, network server 203 transmits both the request and the user's current position information to contents server 204.

Contents server 204 selects the information that matches the user's contents request and also corresponds to the user's current position. The resulting selected information is transmitted to mobile terminal 200 via network server 203, communications network 202, and base station 201. For example, mopera™ of NTT Docomo, Inc. offers a variety of community information, a railway connections guide, a bus guide, spot news, and others.

In the meantime, the above-described features (a6) through (a8) are effective in reducing the cost of pictures (running cost). With a digital camera, since no additional cost would be caused unless picture images that have been taken are printed out, a user is likely to obtain a great amount of image data, for example, during a trip. If a user goes on a trip with a 3,000,000-pixel digital camera and a memory medium of a capacity of 64 MB, 70 picture images or more can be obtained. At that time, the number of picture images the user can obtain is increased as the compression ratio in the JPEG is increased, or as the resolution of picture images is lowered.

With such a great amount of image data, a user would be faced with difficulties in managing and classifying the image data. In the case of picture images taken with a conventional camera, a user normally asks a DPE (Development, Printing, Enlargement) shop to develop the pictures. Taking a look at the developed pictures, the user recognizes when and in what situation the picture was taken.

Meanwhile, in order to recognize what picture images are contained in some digital data, the images must be shown on a display of a PC or the like.

Accordingly, the user first shows picture images on a display to recognize when, where, with whom, and in what situation the pictures were taken. After that, for the purpose of managing the picture images, the user may give any suitable file names to the pictures before storing them, or may store the picture images under a directory given a suitable directory name. Additionally, a database software tool could be utilized to manage the picture images. In that case, image data to be stored therein must be associated with the classification items prepared in the database software, such as “cherry-blossom viewing”, “honeymoon”, and “sports day”, and this associating must be carried out by the user himself.

In this manner, a digital camera is advantageous in that a great amount of digital image data can be obtained at a reasonable cost. However, the management of such a huge amount of data would be troublesome to a user. Hence it is hoped that an easy way to manage the great amount of image data generated by digital cameras is provided, so that users are freed from the troublesome management of image data.

There have already been proposed methods for facilitating image data classification in which position information representing where image data was obtained is stored. The following are publicly known examples: “Image Recording Apparatus and Image Reproducing Apparatus”, Japanese Unexamined Patent Application Publication No. HEI 5-110972; “Electronic Still Camera”, Japanese Unexamined Patent Application Publication No. HEI 5-207408; “Still Camera Which Records Direction Information and Reproduction Method”, Japanese Unexamined Patent Application Publication No. HEI 11-69280; “Image Recording/Reproducing Apparatus”, Japanese Unexamined Patent Application Publication No. HEI 9-252454; “Electronic Camera”, Japanese Unexamined Patent Application Publication No. HEI 9-322109; “Image Data Reproduction Method and Image Data Management Method”, Japanese Unexamined Patent Application Publication No. HEI 10-233985; and “Information Processing Apparatus”, Japanese Unexamined Patent Application Publication No. HEI 11-17908.

In the techniques disclosed in HEI 5-110972, HEI 5-207408, and HEI 9-252454, position information is received from an external apparatus, and then stored in a recording medium together with image data. That is, since the position information received from the an external apparatus is directly stored as it is, it is impossible to add any other information, such as “with whom the image data was obtained”. Accordingly, a user is notified merely of where the image data was obtained, and any other information about the image data cannot be provided to the user.

In the techniques disclosed in HEI 9-322109, HEI 10-233985, and HEI 11-17908, GPS is employed to obtain a user's current position. The current position or some information calculated from the current position is utilized as position information. Using GPS or a map database, “calculation of the current position” and “cooperation with a map database” are realized. Like the above-cited publicly known examples, it is possible to label the image data with the information relating to the current position but not with any other information. Further, GPS signals transmitted from GPS satellites have only latitude and longitude data. Hence, in order to identify what is located at some latitude and longitude, a map database is separately required.

Furthermore, in the technique disclosed in HEI 11-69280, direction information, which represents in what direction image data was obtained, is obtained by a direction sensor. As such direction sensors are large and expensive, they seem to be inferior in practicality.

Meanwhile, as described above, a positioning service, such as mopera™ of NTT Docomo, Inc., selects the information that matches a user's contents request and that also corresponds to the user's current position, and the selected information is then provided to the user. This service, however, would make no contribution to facilitating management and classification of a great amount of image data.

### SUMMARY OF THE INVENTION

With the foregoing problems in view, a subject of the present invention is to realize a service that facilitates management and classification of image data obtained by a digital camera, and that also provides a user with various types of information relating to a place where the image data has been obtained.

In order to accomplish the above subject, according to the present invention, there is provided an image data storing system comprising: an image obtaining apparatus for obtaining image data of a subject; a storage means for storing the image data, which has been obtained by the image obtaining apparatus; a means for obtaining site information representing a site at which the image data has been obtained by the image data obtaining apparatus; a means for obtaining subject information identifying the subject of the image data; and an information adding means for adding both the site information and the subject information to the image data, which is to be stored into the storage means.

As one preferred feature, the image data storing system further comprises a means for calculating an image-shooting direction, in which shooting of an image of a subject has been carried out by the image obtaining apparatus, based on both first position information, representing a position in which the image obtaining apparatus is located, and second position information, representing a position in which the subject of the image data is located, both of which first position information and the second position information are obtained by the site information obtaining means, as the site information, when the image data of the subject has been obtained, and the information adding means is operable to add the calculated image-shooting direction to the image data, which is to be stored into the storage means.

As another preferred feature, the image data storing system further comprises: a means for transmitting add-on information; and a means for receiving the add-on information from the add-on information transmitting means in the vicinity of the site at which the image data of the subject has been obtained, and the information adding means is operable to add the add-on information, which has been received by the add-on information receiving means, to the image data, which is to be stored into the storage means.

As still another preferred feature, the add-on information may be regional information relating to a site at which the image data is obtained, and the site information obtaining means serves also as the add-on information receiving means to receive and obtain the regional information as the site information. Further, the regional information may include shop/establishment information about one or more shops and/or establishments in the vicinity of the site at which the image data has been obtained.

The present invention guarantees the following advantageous results.

(1) Since image data obtained by image data obtaining apparatus is stored in a storage means with position information (the place where the image data has been obtained) and subject information having been added thereto, it is possible to provide users with such useful information for managing/classifying the image data. Hence the users are allowed to use the position information and the subject information added to the image data to manage/classify a great amount of image data obtained by an image obtaining apparatus such as a digital camera, with significant ease. Further, the added subject information would help the users recognize with whom the image data has been obtained. Furthermore, it would also be possible to classify the image data automatically, based on such position information and subject information, using a dedicated software tool.

(2) Since the date and time when the image data was obtained is added to the image data, it is not only possible to facilitate managing/classifying a huge amount of image data based on the date and time, but it is also possible to realize an advanced-quality of classification of the image data, based on the date and time, the position information, and the subject information.

(3) Since an image-shooting direction, which has been calculated based on the position of an image obtaining apparatus and the position of a subject of image data, is added to image data, it is possible to provide a user with information about along which direction (where is viewed from where) the image data has been obtained. Further, since the image-shooting direction is determined according to these two items of position information, any geomagnetism-employed direction sensor is no longer be required, which necessitates expensive and large-scaled circuits, for obtaining the image-shooting direction. Furthermore, by employing a latitude/longitude calculation system of high accuracy, such as GPS, it would be possible to obtain an accurate image-shooting direction with an inexpensive, mobile, construction.

(4) Background information is identified based on the thus obtained image-shooting direction, the position information, and geographic data, and is then added to the image data. It is thus possible for a user to obtain information about the background of the image data, which information is useful for classifying/managing the image data, with no need for performing any particular operation.

(5) Since add-on information sent out in the vicinity of the place where image data has been obtained is received and then added to the image data, it is possible to provide a user (a person who takes picture images) with various kinds of useful information (for example, advertisement information relating to a place where the image data has been obtained, and shop/establishment information in the vicinity of the place). Accordingly, an information sender (service provider) sends out shop/establishment information as well as company ads and event ads of particular companies and organizations in such a manner that the sent-out information can travel a limited distance to reach the users who are staying in that limited area, so that the service provider can charge the companies, organizations, and shops/establishments for such information transmission.

(6) If such add-on information is regional information relating to the place where the image data has been obtained, the regional information may be used as position information representing a place where the image data has been obtained. It is thus possible to obtain the position information merely by receiving such regional information, with no need for using any latitude/longitude calculation system such as GPS or any existing positioning service. At that time, since the regional information may contain advertisement information relating to the place where the image data has been obtained or information about shops/establishments in the vicinity of the place, the regional information is useful for a user (a person who takes picture images) not only to obtain the position information, as described above, but also to obtain the advertisement information and the shop/establishment information.

(7) Generally speaking, because a nonvolatile memory medium built in a digital camera (an image obtaining apparatus) has small capacity for its high price, it is necessary to move the image data being temporarily held in the nonvolatile memory medium (storage means) to an external recording medium having a great amount of capacity. As a result, a time lag would be caused between when image data is obtained and when the data is stored into the storage medium. Accordingly, both the date and time the image data was obtained and the date and time the regional information was received should be stored. On the basis of these dates and times, the appropriate one, whose date of receipt corresponds to the date and time the image data was obtained, is selected from plural items of regional information so as to be added to the image data. As a result, even if the above-mentioned time lag occurs, it is still possible to add the most appropriate regional information having been received in the vicinity of the place where the image data was obtained to the image data, that is, an accurate item of position information corresponding to the place where the image data has been obtained can be added to the image data.

(8) Since not only shop/establishment information but also route information about a route, from where image data has been obtained (the site at which photographing has been carried out) to the shop or establishment, is added to the image data, it is always possible to show a user the way to the shop or establishment from where the image data has been obtained. Further, it is also possible to show a user the way to the shop/establishment, not only at the time the image data is actually obtained but also at the time the user revisits the place where the image data has been obtained, thereby making the shop/establishment more appealing to the user.

(9) Since image data stored in an storage medium is displayed on a browsing means (image viewer) together with various types of information added to the image data, it is possible for a user to use the image viewer to browse the image data and various types of information added to the image data.

(10) In response to a request from a user, route information about a route from a browsing place, where image data is being browsed with the browsing means (a current position of the image viewer), to a shop or establishment whose information is displayed on the browsing means, is notified to the browsing means and is displayed thereon. It is thus possible for a user, while browsing some shop/establishment information on the browsing means, to obtain route information about a route from the browsing place to the shop or establishment. As a result, the shop or establishment would be more appealing to the user.

(11) Since the kind of information a user demands is previously registered in such a manner that only the shop/establishment information that matches the registered information kind is extracted, it is possible to selectively add the information that is useful to the user (for example, information belonging to the user's fields of interest) to the image data, which is then provided to the user.

(12) Partly since a person who is to be a subject of a picture image carries a mobile terminal that transmits a identification information (ID) unique to the person, and partly since the ID received from the mobile terminal is then added to the image data as subject information at the time the image data is obtained, it is possible to significantly easily obtain an ID (subject information) which identifies the subject of the image data. At that time, IDs of the persons who are to be the subjects of the images to be taken by an image obtaining apparatus are previously registered in such a manner that only the registered IDs are extracted from IDs having been received, so as to be added to the image data. It is thus possible to prevent, with certainty, erroneous adding of third parties' IDs having no relationship with the image data.

(13) Since the above functions of a mobile terminal may be equipped to a mobile telephone, thereby eliminating the necessity of a user to buy any dedicated mobile terminal separately, it is possible to realize a means for obtaining subject information (IDs), with significant ease.

(14) Since position information representing a position where the image data is obtained may be acquired as latitude/longitude provided by the GPS, it is possible to obtain highly accurate position information with significant ease, even with an inexpensive, portable construction.

(15) Since such position information may be obtained by receiving any positioning service through a mobile telephone, thereby making it possible to obtain the position information significantly easily, even with an inexpensive, portable construction.

(16) Since both the function for adding position information and subject information to image data and the function for storing the thus added information may be provided to an image obtaining apparatus such as a digital camera, it is possible to realize like effects and profits to those of the above-described item (1).

(17) Since both the function for adding position information and subject information to image data and the function for storing the thus added information may be provided to an image data storing device such as a hard disc unit, it is possible to realize like effects and profits to those of the above-described item (1).

(18) Since a mobile terminal, which is carried by a person who is to be a subject of a picture to be taken by an image obtaining apparatus, has a means for holding ID information unique to the person, and also has a means for transmitting the ID information, it is possible for the mobile terminal to notify a subject information obtaining means of the ID information as subject information. Further, since the mobile terminal may have a means for obtaining its current position and also a means for transmitting this current position, it is possible for the mobile terminal to notify a position information obtaining means of the terminal's current position as position information representing a place where image data has been obtained.

(19) An image data classification program instructs a computer to function as the following: a means for generating a plurality of classification items in terms of at least one selected from the group consisting of the regional information, the subject information, and the date and time of obtaining image data, all of which are added to respective items of image data; and a means for assigning the items of image data to the respective classification items, which have been generated by the above-mentioned item-generating means, in terms of at least one selected from the group consisting the regional information, the subject information, and the date and time of obtaining image data. Accordingly, the computer executes the image classification program to automatically classify plural items of image data, each of which is labeled with the regional information, the subject information, and the date and time when the image data was obtained. This would facilitate creation of image databases (personal albums, or the like), one for each subject of the image data, separately.

(20) A background information designating program instructs a computer to function as the following: a means for calculating an image-shooting direction, in which shooting of an image of a subject has been carried out by an image obtaining apparatus of an image data storing system to obtain image data, based on both first site information, representing a site at which the image obtaining apparatus is located and second site information, representing a site at which the subject of the image data is located, when the image data has been obtained; and a means for determining a background subject, which presumably appears in the background of the image data, as background information, based on the image-shooting direction, which has been calculated by the image-shooting-direction calculating means, and the first site information and/or the second site information. It is thus possible for the computer, given the position information of the image obtaining apparatus and of the subject of the image data, to automatically designate the background information by executing the background information designating program.

(21) A traveling route designating program instructs a computer to function as the following: a means for determining a user's traveling route, along which the user has traveled while obtaining a plurality of items of image data at different sites using an image obtaining apparatus, among a plurality of traveling routes, based on both site information representing a site at which an individual item of image data has been obtained and the date and time when the individual item of image data has been obtained, both of which have been added to the individual item of image data; and a display control means for performing a control process on a display section, which is associated with the computer, to display the traveling route determined by the traveling route determining means, along with surrounding geographic data in such a manner that the traveling route superimposes over the surrounding geographic data. By executing the program, accordingly, it is possible for the computer to automatically designate a user's traveling route along which the user has traveled while obtaining a series of items of image data, according to those items of image data, each of which is labeled with the site information and the date and time of obtaining the image data. In addition, it is also possible for the computer to show on a display the thus designated traveling route together with its surrounding geographic data.

Other subjects and further features of the present invention will be apparent from the following detailed description when read in conjunction with the accompanying drawings.

### BRIEF DESCRIPTION OF THE DRAWINGS

FIG. 1 is a block diagram schematically showing an image data storing system of a first embodiment of the present invention;

FIG. 2 is a diagram depicting an example of a data structure (format) of digital image data of the first embodiment;

FIG. 3 is a flowchart illustrating a procedure carried out by an image data storing system of the first embodiment;

FIG. 4 through FIG. 6 are diagrams each depicting operation of an image data storing system of the first embodiment;

FIG. 7 is a block diagram schematically showing an image data storing system of a second embodiment of the present invention;

FIG. 8 is a diagram depicting an example of data structure (format) of digital image data of the second embodiment;

FIG. 9 is a flowchart illustrating a procedure carried out by an image data storing system of the second embodiment;

FIG. 10 through FIG. 12 are diagrams each depicting operation of an image data storing system of the second embodiment;

FIG. 13 is a block diagram schematically showing an image data storing system of a third embodiment of the present invention;

FIG. 14 is a diagram depicting an example of data structure (format) of digital image data of the third embodiment;

FIG. 15 is a view for describing a process executed by a traveling route designating program of the third embodiment;

FIG. 16 is a diagram for describing an image data classification program executed in the third embodiment;

FIG. 17 is a diagram for describing a traveling route designating program executed in the third embodiment;

FIG. 18 is a block diagram schematically showing a modified example of an image data storing system of the third embodiment;

FIG. 19 is a flowchart illustrating a procedure carried out by the image data storing system of FIG. 18;

FIG. 20 is a block diagram schematically showing an image data storing system of a fourth embodiment of the present invention;

FIG. 21 is a block diagram depicting an overview of an image data storing system of the fourth embodiment;

FIG. 22 is a diagram depicting an example of data structure (format) of digital image data of the fourth embodiment;

FIG. 23 is a flowchart illustrating a procedure carried out by an image data storing system of the fourth embodiment;

FIG. 24 is a block diagram schematically showing an image data storing system of a fifth embodiment of the present invention;

FIG. 25 is a flowchart illustrating a procedure carried out by an image data storing system of the fifth embodiment;

FIG. 26 is a diagram depicting a common example of data structure (format) of digital image data; and

FIG. 27 is a view for describing a concept of a common positioning service.

### DESCRIPTION OF THE PREFERRED EMBODIMENTS

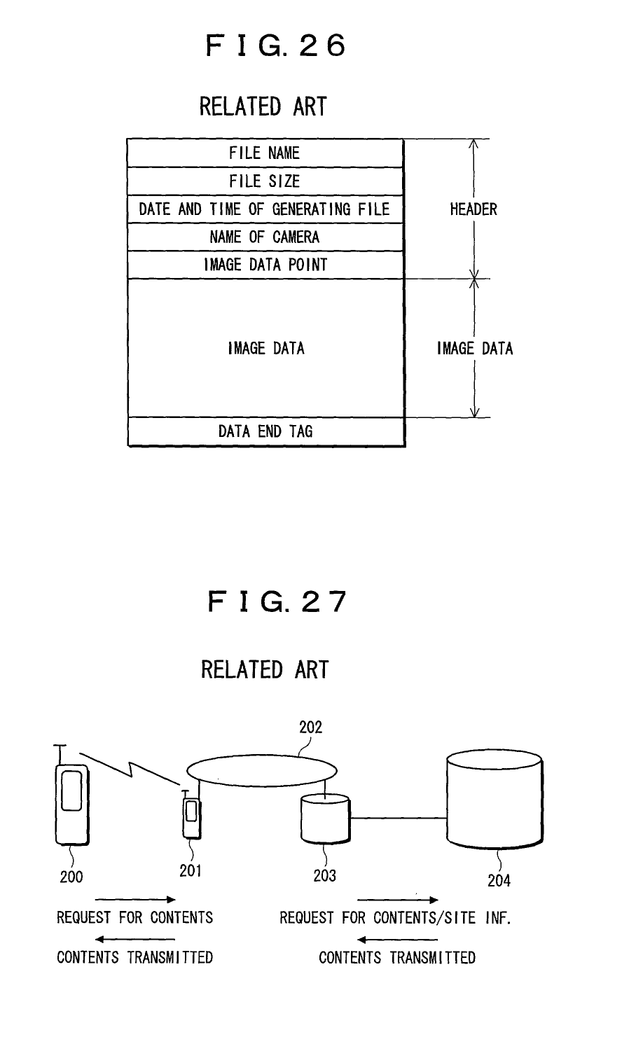

Digital image data obtained by an image obtaining apparatus (image input device) such as a digital camera, is normally constituted of not only the image data itself but also its file size and the date and time (file-generating date and time) when the image data was generated, as shown in FIG. 26. Only with such information, however, it is not possible for a user to recognize where and in what situation, and with whom the image data has been obtained.

Accordingly, as will be described later in a first and a second embodiment, the present invention adds (labels) and stores in image data various types of information, that is, information (site information) about where the image data has been obtained, event information, and information (subject information) of the subject of image data), together with the date and time when the image data was obtained, thereby making it possible for a user to know “when”, “with whom”, and “in what situation” the image data was obtained.

Additionally, as will be described later in the third through fifth embodiments, the present invention realizes a brand-new service, in which transmitting means for transmitting label information (add-on information) including various types of information are installed where many photos would be taken (tourist spots, for example), and such information is added (hereinafter also called “labeled”) to the image data obtained by the users.

More precisely, a company (service provider) that provides the above-mentioned service receives advertisement contracts (for providing company publicity and event ads) from advertisers (companies, stores, and shops neighboring tourist spots), and transmits their advertisements. The service provider sends out information containing such advertisements, and the information is automatically labeled to/stored in image data obtained by users, when the image data is stored on the user side. As a result, it is possible for the service provider to earn charges for the advertisement transmission, while it is possible for users to receive such useful advertisement information and also to receive information that would help them in classifying the image data they have obtained.

Various embodiments of the present invention will now be described with reference to the relevant accompanying drawings.

[1] First Embodiment:

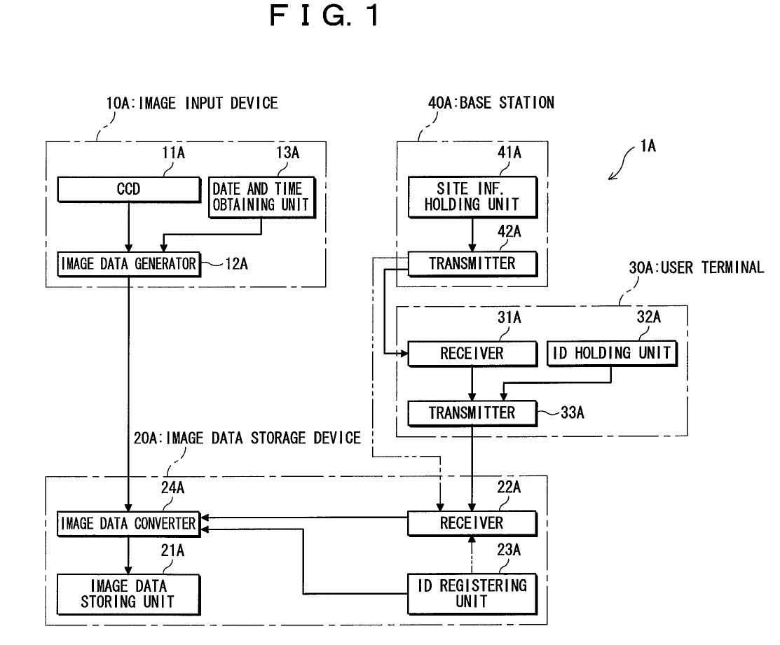

FIG. 1 depicts a construction of an image data storing system of a first embodiment of the present invention. Image data storing system 1A of the first embodiment includes image input device 10A, image data storage device 20A, user terminal 30A, and base station 40A.

Image input device (image obtaining apparatus) 10A, for example, a digital camera carried by a user, generates/obtains image data in response to users' operations. Image input device (hereinafter called a digital camera) 10A includes CCD 11A, image data generator 12A, and date and time obtaining unit 13A.

CCD 11A receives light reflected from a subject to convert the light into digital data. Image data generator 12A generates image data from the digital data output from CCD 11A, and outputs the image data in the form of an image file.

Date and time obtaining unit (date and time obtaining means) 13A, which is realized by a built-in clock function of digital camera 10A, obtains the data and time when image data is generated/obtained by CCD 11A and image data generator 12A. Image data generator 12A converts digital data, which has been obtained by CCD 11A, to a JPEG, and also serves as a means for labeling the date and time obtained by date and time obtaining unit 13A to the image data (image file), as the date and time when the image data was obtained (file-generating date and time; hereinafter also called “the date and time of photographing”).

Image data storage device 20A, which is connected with digital camera 10A via a cable supporting USB (Universal Serial Bus) so as to store image data obtained by digital camera 10A, is carried by a photographer (user) together with digital camera 10A. In use, image data storage device 20A can be provided in the form of a hard disc unit, for example, and includes image data storing unit 21A, receiver 22A, ID holding unit 23A, and image data converter 24A.

Image data storing unit (storage means) 21A, or a hard disc itself, for example, stores image data (image file) obtained by digital camera 10A.

Receiver 22A, which is for receiving signals from user terminal 30A (or base station 40A), serves as a site information obtaining means for obtaining site information representing a site at which the image data has been obtained, and also serves as a subject information obtaining means for obtaining subject information {identification information (ID)} identifying the subject of the image data (described later). In the present description, “site information” is also called “position information” without making a distinction between them.

ID registering unit (means for registering ID information) 23A, which is realized in use by RAM (Random Access Memory), previously registers IDs of persons (users) who are to be the subjects of pictures to be taken by digital camera 10A, and holds the IDs in the form of a table.

Image data converter (information adding means) 24A carries out an image data converting process, in which position information and subject information (ID), having been received by receiver 22A, are both added in a header area of image data input from digital camera 10A. The resulting converted (or such information-added) image data is stored in image data storing unit 21A.

At that time, image data converter 24A serves also as an ID information extracting means to extract the IDs which coincide with those registered in the user table of ID registering unit 23A, among the IDs having been received and acquired by receiver 22A. Image data converter 24A labels the thus extracted IDs (by an ID information extracting means) to the image data. In this instance, receiver 22A, as an alternative to image data converter 24A, might serve as the above-mentioned ID information extracting means to refuse the IDs that are not registered in the user table.

User terminal 30A is a mobile terminal carried by a person (user) who is to be the subject of pictures taken by digital camera 10A. User terminal 30A transmits an ID unique to the user, and is realized in use by, for example, a mobile telephone (including a PHS terminal).

User terminal 30A includes receiver 31A, ID holding unit 32A, and transmitter 33A.

Receiver (means for obtaining current position) 31A obtains the current position of user terminal 30A. In the first embodiment, receiver 31A receives and obtains the position information from the one of base stations 40A, which is located closest to user terminal 30A, as the current position of user terminal 30A. At that time, in a case where user terminal 30A is a mobile telephone, it would be possible to utilize a positioning service, say, mopera™ of NTT Docomo, Inc., as a method for receiving and obtaining site information from base station 40A.

ID holding unit (ID information holding means) 32A holds the above-mentioned ID (personal data, user information, authorized user information) unique to a user.

Transmitter 33A serves as a means for transmitting ID information, which transmits the ID (subject information) held in ID holding unit 32A to image data storage device 20A, and also as a means for transmitting the current position (site information) of user terminal 30A, which has been received and obtained by receiver 31A.

Both the subject information (ID) and the site information (current position) transmitted from transmitter 33A are received by receiver 22A of image data storage device 20A. More precisely, at the time digital camera 10A takes a photo of a user who is carrying user terminal 30A, receiver 22A receives subject information (ID) and site information (current position) from user terminal 30A, thereby serving both as a means for obtaining site information representing a site at which the image data is obtained and as a means for obtaining subject information identifying the subject of the image data.

Base stations 40A, each of which includes site information holding unit 41A and transmitter 42A, are previously installed in predetermined regions. Site information holding unit 41A previously holds position information corresponding to a region in which base station 40A is installed, and transmitter 42A always sends out (broadcasts) such position information held in site information holding unit 41A in such a way that the position information travels in the corresponding predetermined region.

In the above example, though position information is transferred, as current position information, from base station 40A to image data storage device 20A via user terminal 30A, it might alternatively be possible to allow receiver 22A of image data storage device 20A to directly receive/obtain the position information transmitted from base station 40A as the current position information (shown by the double-dotted chain line in FIG. 1).

Further, transmitter 33A and receiver 22A communicate with one another through the communications function of a mobile telephone, or otherwise, it might be possible to utilize an interface (say, a Bluetooth™ connector) dedicated to short-haul radio communications, which is equipped to a mobile telephone. Furthermore, instead of the use of a USB cable in the above example for realizing communications between digital camera 10A and image data storage device 20A, the communications can be carried out by wireless.

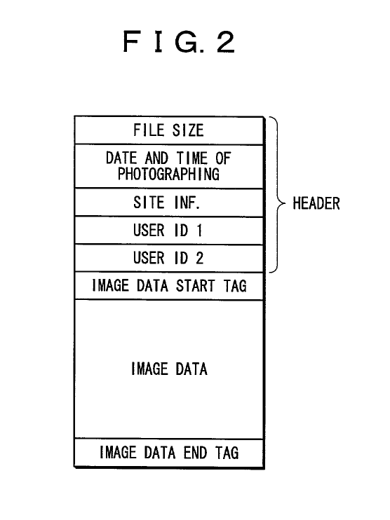

FIG. 2 shows an example of a data structure (format) of digital image data of the first embodiment. Digital image data (image file) stored in image data storing unit 21A of image data storage device 20A is formed of not only an area (sandwiched between image data start tag and an image data end tag) recording the image data itself but also another area (header) recording various types of information relating to the image data.

Referring now to FIG. 2, the header stores a file size and the date and time of photographing, as is done in conventional techniques, and in the first embodiment, there are additionally stored position information about a site at which photographing is carried out and also one or more user IDs (a couple of IDs are stored in FIG. 2), both of which have been added by image data converter 24A. Here, user IDs to be added to image data are limited to those that are previously registered in ID registering unit 23A by image data converter 24A, which serves as the above-mentioned ID information extracting means.

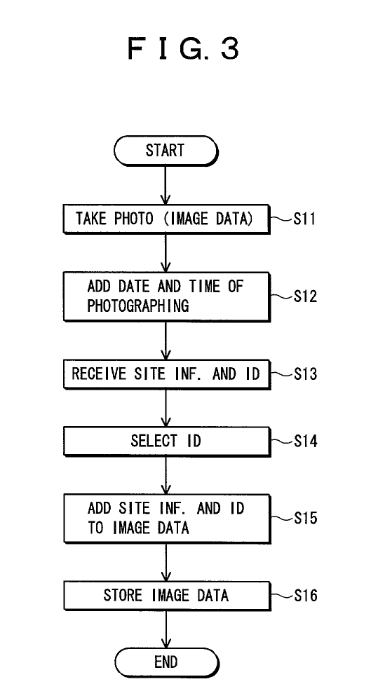

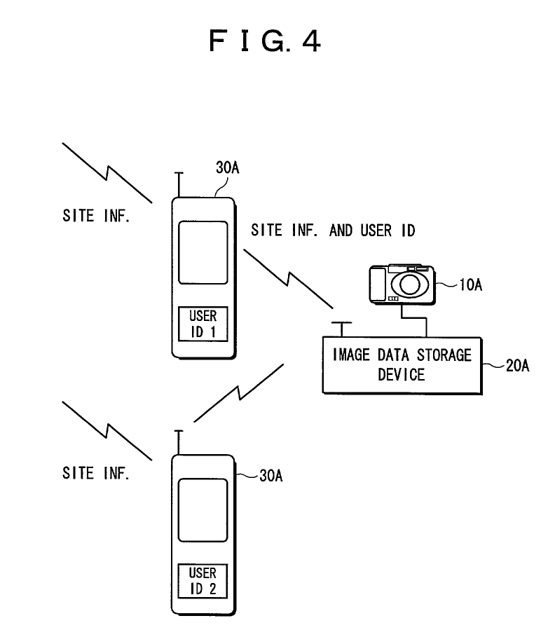

In accordance with the flowchart (step S11 through step S16) of FIG. 3, making reference to FIG. 4 through FIG. 6, a description will be made hereinbelow of a procedure executed by image data storing system 1A of the first embodiment. Here, FIG. 4 through FIG. 6 illustrate operations of the system of the first embodiment.

If a photographer takes a picture of a person (subject), who carries user terminal 30A, with digital camera 10A (step S11), date and time obtaining unit 13A obtains the date and time of photographing, which is then added by image data generator 12A in the header of the image data received from CCD 11A (step S12). The image data thus labeled with the date and time of photographing is then input from digital camera 10A to image data storage device 20A via a USB or the like.

At that time, receiver 22A of image data storage device 20A receives/obtains position information of the subject person, that is, position information of user terminal 30A which the subject person carries and also the subject person's user ID (subject information) (step S13).

Among plural user IDs having been received, image data converter 24A extracts/selects an ID which is registered in ID registering unit (user table) 23A (step S14). After that, the selected ID and the received position information are then written in the header of the image data received from digital camera 10A (step S15), which image data is then stored into image data storing unit 21A (step S16).

In the first embodiment, the header of the image data stores the position information and the subject information (user information), thereby making it possible to label the image data with not only the date and time of photographing but also information about the site at which the picture was obtained and information about the subject of the picture. That is, it is now possible for a user to recognize “when”, “where”, and “with whom” the image data was obtained.

Referring now to FIG. 4, for example, the photographer and the accompanying person (hereinafter both called “users”) carry user terminals 30A, one for each user, for transmitting user IDs unique to the respective users. At the time of storing image data, such user IDs (user information) are received along with the position information, and then stored into the header of the image data.

In the example of FIG. 4, there are shown two user terminals 30A. In such a case, the two users, who carry the user terminals 30A, might be a pair of a photographer and an accompanying person, or otherwise, might be a couple of persons who are to be subjects of pictures to be taken. In this case, two items of position information are received, one from each user terminal 30A. Both of the items might be labeled to the image data, or otherwise, either one of them might be selected to be labeled to the image data.

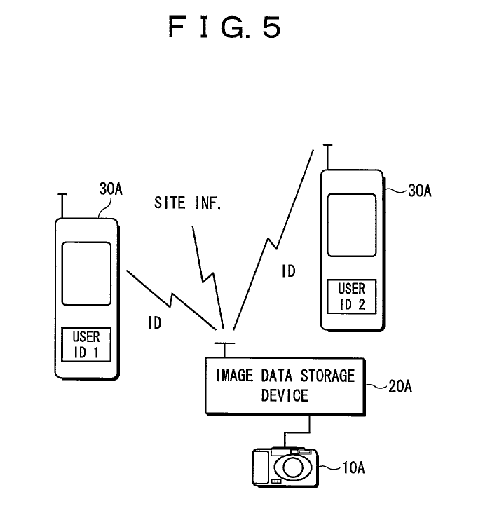

Referring now to FIG. 5, this example depicts a case where only the user ID (user information) is sent out by user terminal 30A. In the example, position information is received by receiver 22A of image data storage device 20A directly from base station 40A or GPS, with no intervening user terminal 30A (see double-dotted chain line of FIG. 1).

In image data storage device 20A, user IDs are previously registered in ID registering unit 23A in the form of a user table. Only the IDs that coincide with those which are registered in ID registering unit 23A are extracted/selected to be labeled to the image data. Accordingly, IDs that are not registered in ID registering unit 23A can never be stored into the header of the image data, thereby preventing any third party's information from being stored erroneously.

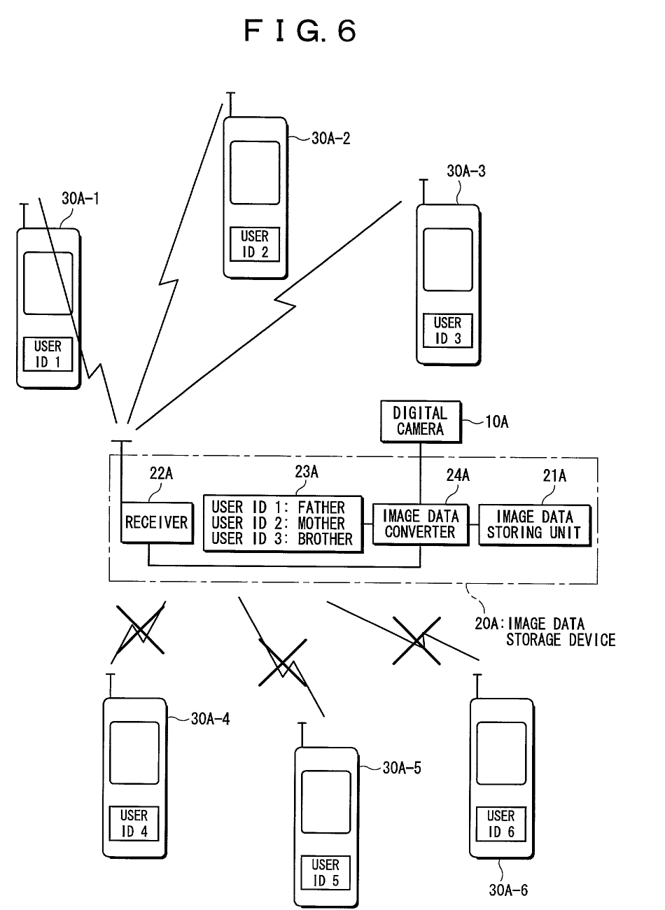

Referring now to FIG. 6, there are previously registered in the user table (ID registering unit 23A) three IDs, ID 1, ID 2, and ID3, for the photographer's father, mother, and brother, respectively. As a result, provided a picture of these three persons, carrying user terminals 30A-1 through 30A-3, is taken in the presence of third parties (ID 4 through ID 6) carrying user terminals 30A-4 through 30A-6, which sends out ID 4 through ID 6, such unregistered IDs (ID 4 through ID 6), even if received by receiver 22A of image data storage device 20A, would never be labeled to the image data.

At that time, image data storage device 20A and user terminal 30A can be integrated into one device (not shown).

Further, each user might carry image data storage device 20A so as to store the user's image data obtained by digital camera 10A therein. If two or more users are in one picture, the image data is stored separately in each of the individual users' image data storage devices 20A. Upon storing the image data, image data storage device 20A or digital camera 10A receives position information, so that both the position information and the user ID held in image data storage device 20A are stored in the header of the image data. In this manner, when every user carries image data storage device 20A of the user's own, the device would be able to serve as the user's personal album.

In addition, image data storage device 20A is communicably connected with another image data storage device 20A, thereby making it possible to transfer image data therebetween. In such a case, at the transfer of the image data, IDs or position information in the header of the image data should not be rewritten, so that the date and time of photographing and user IDs, once recorded in original image data in image data storage device 20A, is never changed. Likewise, image data received from another user's image data storage device 20A can maintain its date and time of photographing and the other user's ID, having been written therein. As a consequence, it is possible to prevent image data from being labeled with any position information or IDs having no relationship to the image data, and it is also possible for users to distinguish the image data which has been taken by themselves from that which has been given by someone else. It is still possible to accurately recognize where the image data has been obtained and who is the subject of the image data.

In this manner, with image data storing system 1A according to the first embodiment of the present invention, since image data obtained by digital camera 10A is stored in image data storing unit 21A with position information and IDs being labeled thereto, it is possible to provide users with such useful information for managing/classifying the image data.

Hence, users are allowed to use the position information and the IDs added to the image data to manage/classify a great amount of image data obtained by digital camera 10A, with significant ease. Further, the added IDs would help the users to recognize with whom the image data has been obtained. Furthermore, as will be described later in a third embodiment, it would be possible to use a dedicated software tool for realizing an automatic classification of image data based on position information and IDs.

Moreover, since digital camera 10A labels image data with the date and time of photographing (the date and time when the image data is obtained), it is possible not only to manage/classify a huge amount of image data with ease, based on the date and time of photographing, but also to realize an advanced-quality of classification, based on the date and time of photographing, position information, and IDs. As has already been described above, in a well-known technique (Japanese Unexamined Patent Application Publication No. HEI 5-207408) for identifying a position where an image is obtained, the site information is calculated as an item of management information at the time photo-taking is carried out. With this technique, it is possible to identify where the image data is obtained using GPS, but it is still impossible to recognize when and by whom the image is obtained. In comparison with such a technique, in image data storing system 1A of the first embodiment of the present invention, IDs of the persons (users) who are subjects of a picture image are labeled to the image data, and based on these IDs, the date and time of photographing, position information, and an advanced grade of classification can be realized.

In the present embodiment, additionally, a person who is to be a subject of an image carries user terminal 30A that transmits a user ID unique to the person, and the ID received from user terminal 30A is then labeled to the image data as subject information at the time the image data is obtained, thereby making it possible to significantly easily obtain an ID (subject information) which identifies the subject of the image data. At that time, IDs of the persons who are to be subjects of the images to be taken by digital camera 10A are previously registered in ID registering unit 23A. Since only such registered IDs are extracted among IDs having been received, so as to be labeled to the image data, it is possible to prevent, with certainty, erroneous labeling of third parties' IDs having nothing to do with the image data.

Further, since the function of user terminal 30A can be equipped to a mobile telephone, thereby eliminating the necessity of a user buying any dedicated user terminal separately, it is possible to realize a means for obtaining subject information (IDs), with significant ease.

Still further, since position information representing a position where the image data is obtained can be acquired as latitude/longitude provided by GPS, it is possible to obtain highly accurate position information significantly easily, even with an inexpensive, portable construction. Otherwise, such position information can be obtained by receiving any positioning service through a mobile telephone, thereby making it possible to obtain the position information with significant ease, even with an inexpensive, portable construction.

In the above description of the first embodiment, digital camera 10A is connected with image data storage device 20A via a USB. Digital camera 10A and image data storage device 20A can be integrated instead, thereby providing digital camera 10A with the function of image data storage device 20A (the functions of image data storing unit 21A, receiver 22A, ID registering unit 23A, and image data converter 24A).

[2] Second Embodiment:

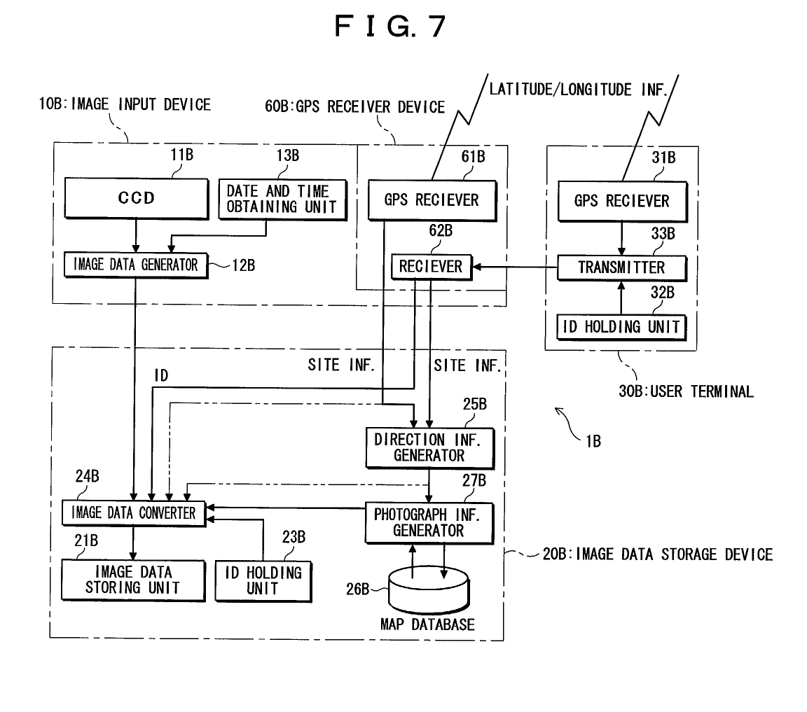

FIG. 7 depicts a construction of an image data storing system of a second embodiment of the present invention. Image data storing system 1B of the second embodiment includes image input device 10B, image data storage device 20B, user terminal 30B, and GPS receiver device 60B.

Like image input device 10A of the first embodiment, image input device (image obtaining apparatus) 10B, for example, a digital camera carried by a user, generates/obtains image data in response to users' operations. Image input device (hereinafter called a digital camera) 10B includes CCD 11B, image data generator 12B, and date and time obtaining unit 13B, which carry out functions similar to those of CCD 11A, image data generator 12A, and date and time obtaining unit 13A, respectively, and detailed descriptions of these are thus omitted here.

Digital Camera 10B of the second embodiment, as distinct from digital camera 10A of the first embodiment, has GPS receiver device 60B, which includes GPS receiver 61B and receiver 62B. At the time digital camera 10B obtains image data, GPS receiver (means for obtaining current position) 61B receives/obtains information about an accurate current position (latitude/longitude) of digital camera 10B from GPS satellites, and transfers the received information to image data storage device 20B. Receiver 62B, which executes functions similar to those of receiver 22A of the first embodiment, receives various types of information from user terminal 30B, and transfers the information to image data storage device 20B. In this instance, GPS receiver device 60B might be built in image input device 10B, or alternatively, might be realized by a GPS-equipped mobile telephone.

User terminal 30B is a mobile terminal carried by a person (user), who is to be a subject of pictures taken by digital camera 10B. User terminal 30B transmits an ID unique to the user, and is realized in the second embodiment by, for example, a GPS receiver or a GPS-equipped mobile telephone.

User terminal 30B includes receiver 31B, ID holding unit 32B, and transmitter 33B.

GPS receiver 31B executes a function roughly the same as that of receiver 31A of the first embodiment, with the exception that GPS receiver 31B of the second embodiment receives/obtains an accurate current position (latitude/longitude) of a user from an artificial satellite at the time the image of the user is obtained by digital camera 10B.

ID holding unit (means for holding ID information) 32B and transmitter (means for transmitting ID information, means for transmitting current position) 33B execute similar functions to those of ID holding unit 32A and transmitter 33A of the first embodiment, respectively, and their detailed descriptions are thus omitted here. When digital camera 10B takes a picture of a person carrying user terminal 30B, subject information (an ID) and position information (current position) of the subject person, both which have been transmitted from transmitter 33B, are received by receiver 62B of GPS receiver device 60B.

Image data storage device 20B, which is connected with digital camera 10B via a USB cable so as to store image data obtained by digital camera 10B, is carried by a user together with digital camera 10B. In practical use, image data storage device 20B can be provided in the form of, for example, a hard disc unit. It receives not only the image data obtained by digital camera 10B, but also current positions and IDs of a photographer and a subject person of the image data, which are received by GPS receiver device 60B, and their IDs, via digital camera 10B and a USB.

Further, image data storage device 20B has image data storing unit 21B, ID registering unit 23B, image data converter 24B, direction information generator 25B, map database 26B, and photograph information generator 27B.

Image data storing unit (storage means) 21B, like image data storing system 21A of the first embodiment, is a hard disc itself, for example, which stores image data (image file) obtained by digital camera 10B.

ID registering unit (means for registering ID information) 23B, like ID registering unit 23A of the first embodiment, is realized in use by RAM, and previously registers IDs of persons (users) who are expected to be the subjects of pictures to be taken by digital camera 10B, and holds the IDs in the form of a table.

Image data converter (information adding means) 24B carries out an image data converting process, in which subject information (ID), having been received by receiver 62B of GPS receiver device 60B, and position information, direction information (image-shooting direction), and photograph information (background information), all of which will be described later in detail, are added in the header area of the image data input from digital camera 10B. The resulting converted (or such information-added) image data is stored in image data storing unit 21B.

At that time, image data converter 24B, like image data converter 24A of the first embodiment, serves also as an ID information extracting means for extracting the IDs, which coincide with those registered in the user table of ID registering unit 23B, among IDs having been received and acquired by receiver 62B. Image data converter 24B labels the thus extracted IDs (by an ID information extracting means) to the image data.

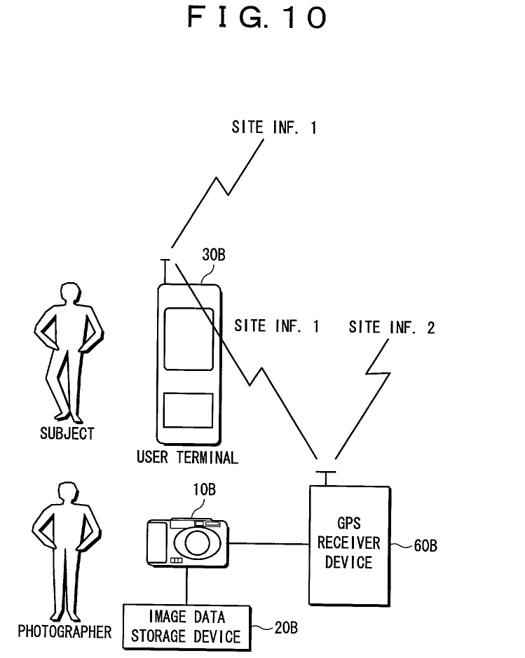

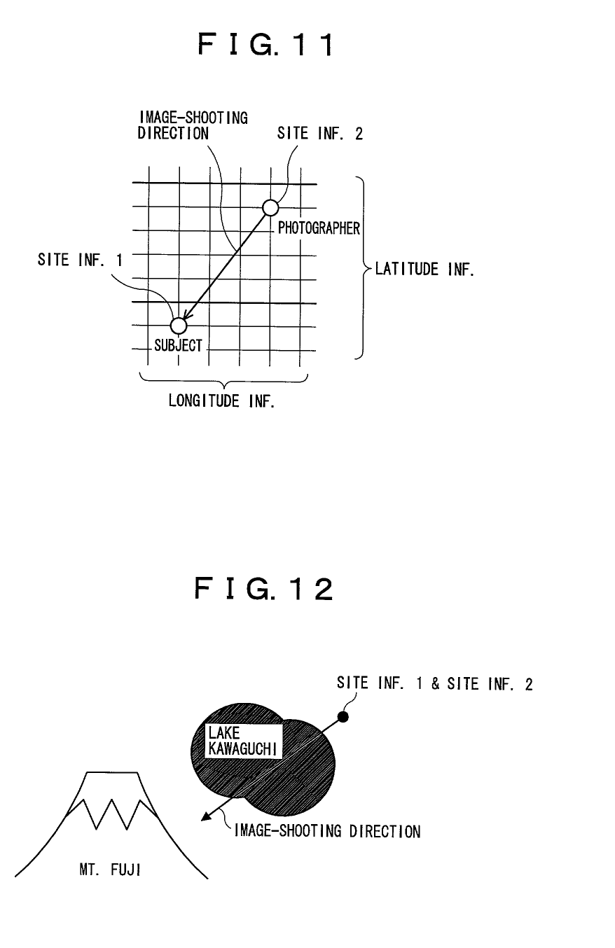

Direction information generator (means for calculating an image-shooting direction) 25B, as will be described later with reference to FIG. 10 and FIG. 11, obtains an image-shooting direction, in which the image data has been shot, based on position information (latitude/longitude) of digital camera 10B, which information is obtained by GPS receiver 61B, and position information of a subject of the image, which information is received from user terminal 30B.

Map database 26B stores geographic data in correspondence with longitude/latitude information.

Photograph information generator (means for identifying a background subject) 27B, as will be described later in detail with reference to FIG. 12, identifies where {eg. place name (photograph information)} image data is obtained, based on a photo-shooting direction calculated by direction information generator 25B, position information (latitude/longitude) of digital camera 10B or that of a subject of the image, and geographic data stored in map database 26B. Photograph information generator 27B may identify a background subject dominating the background of the image data, as background information (photograph information).

Image data converter 24B adds the resulting photograph information (the site at which the image data is obtained and background information), identified by photograph information generator 27B, in a header area of the image data received from digital camera 10B. At that time, image data converter 24B can add the photo-shooting direction (direction information) calculated by direction information generator 25B, and the position information (latitude/longitude) of digital camera 10B or that of the subject of the image, into the header area.

The above-described direction information generator 25B and photograph information generator 27B are realized by dedicated software (a background information designating program). Such a background information designating program is recorded in a computer-readable recording medium, such as a flexible disc, CD-ROM, and others. In the second embodiment, image data storage device 20B has a ROM (Read Only Memory) in which a background information designating program is previously stored, and the CPU (not shown) of image data storage device 20B reads out the program to execute, thereby realizing the functions of direction information generator 25B and photograph information generator 27B.

At that time, the background information designating program may be alternatively recorded in a storage device (recording medium), such as a magnetic disc, optical disc, and magneto-optical disc, and in that case, the program is provided from the storage device to a computer via a communications path. Further, the program might be constructed in such a way as to contain map database 26B storing geographic data.

User terminal 30B communicates with digital camera 10B (GPS receiver device 60B) by radio, while communications between digital camera 10B and image data storage device 20B may be carried out through a USB cable, as described above, or by radio.

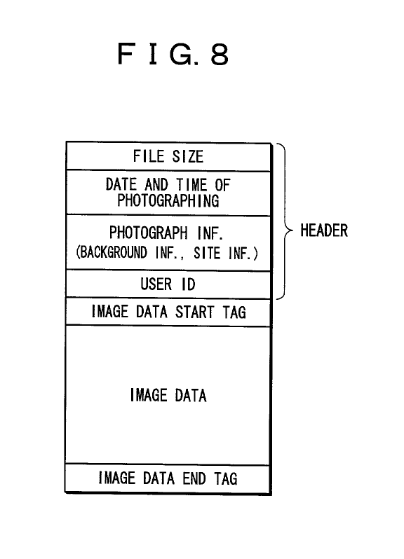

FIG. 8 shows an example of a data structure (format) of digital image data of the second embodiment. As in the first embodiment of FIG. 2, digital image data (image file) stored in image data storing unit 21B of image data storage device 20B is formed of not only an area recording the image data itself but also a header recording various types information relating to the image data.

Referring now to FIG. 8, the header stores a file size and the date and time of photographing, as in conventional techniques, and in the second embodiment, there is additionally stored photograph information, including background information and position information, and also a user ID of a subject of the image data, both of which have been added by image data converter 24B. Here, user IDs to be added to the image data are limited to those that are previously registered in ID registering unit 23B by image data converter 24B, which serves as the above-mentioned ID information extracting means.

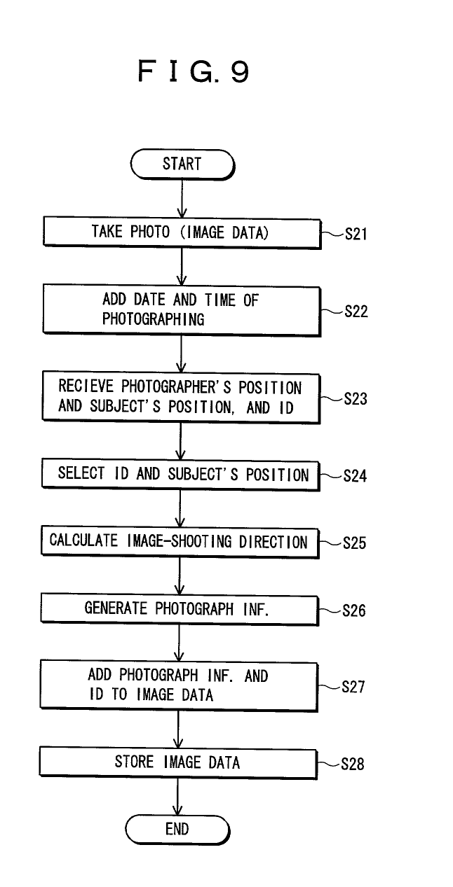

In accordance with the flowchart (step S21 through step S28) of FIG. 9, making reference to FIG. 10 through FIG. 12, a description will be made hereinbelow of a procedure executed by image data storing system 1B of the second embodiment. In this instance, FIG. 10 through FIG. 12 illustrate operations of the system of the second embodiment.

If a photographer takes a picture of a person (subject), who carries user terminal 30B, with digital camera 10B (step S21), date and time obtaining unit 13B obtains the date and time of photographing, which is then added by image data generator 12B into the header of the image data input from CCD 11B (step S22). The image data thus labeled with the date and time of photographing is then input from digital camera 10B to image data storage device 20B via a USB or the like.

At that time, in GPS receiver device 60B, as shown in FIG. 10, GPS receiver 61B receives/obtains, from GPS satellites, position information (latitude/longitude) 2 of digital camera 10B (a photographer) at the time of photographing, and also, receiver 62B receives/obtains, from user terminal 30B carried by a person who is the subject of the image, both position information 1 (or position information of user terminal 30B) at the time of photographing and an ID (subject information) unique to the person (step S23).

Among user IDs having been received, image data converter 24B extracts/selects a user ID which is registered in ID registering unit (user table) 23B. Accompanying this, among plural items of position information 1 that have been received, the position information received from user terminal 30B together with an ID that is registered in ID registering unit 23B is extracted/selected (step S24) to be used for calculating direction information.

Referring now to FIG. 11, direction information generator 25B calculates an image-shooting direction {direction (vector) from the photographer's position to the subject's position} based on the following two items of position information (step S25): position information (latitude/longitude) 1 is the current position of digital camera 10B; and position information (latitude/longitude) 2 is the subject's current position received from user terminal 30B. At that time, if two or more items of position information 2 exist, one of the plural items of position information 2 is selected, or the barycenter of the positions is calculated, to represent those plural positions.

On the basis of the thus obtained position information 1, position information 2, and image-shooting direction, and also of geographic data in map database 26B, photograph information generator 27B identifies the place where (a place name or the like) image data has been obtained and a background subject dominating the background of the image data, as background information (step S26).

That is, in accordance with geographic data of map database 26B, (position information 1 and position information 2) the image data that has been obtained is determined, and what geographic feature lies along the image-shooting direction in terms of the thus determined position information 1 and position information 2, is also determined. The thus determined information is output from map database 26B to photograph information generator 27B. On the basis of this information received from map database 26B, photograph information generator 27B generates photograph information (including position information and background information) to be stored in the image data, and outputs the photograph information to image data converter 24B.

Assuming that a picture is taken in the situation of FIG. 12, photograph information generator 27B generates concrete photograph information such as “viewing Mt. Fuji from Lake Kawaguchi”. This photograph information includes both the site, “Lake Kawaguchi”, at which the image data is obtained and the background subject, “Mt. Fuji”, making it possible for a user to understand what the background subject of the picture image is. As another example, assuming that a picture of a user carrying user terminal 30B is taken at the viewing platform of Mt. Hodakadake with Mt. Yarigatake in the background, photograph information generator 27B generates photograph information such as “photographed at the viewing platform of Mt. Hodakadake with Mt. Yarigatake in the background”.

After that, image data converter 24B then writes the ID, which has been selected in step S24, and the photograph information, which has been generated in step S26, into the header of the image data (step S27), which is then stored in image data storing unit 21B (step S28).

Instead of such photograph information, the header may store direction information calculated by direction information generator 25B and two items of position information (position information 1 and position information 2) obtained by GPS receiver 31B and GPS receiver 61B. Otherwise, the header may store the direction information, position information 1, and position information 2, together with the photograph information (see the double-dotted chain line of FIG. 7).

Otherwise, only position information 1 and position information 2 may be written in the header. In that case, when a user performs image data processing on a personal computer, the above-described background information designating program is activated on the computer to determine background information based on the two times of position information.

In this manner, with image data storing system 1B of the second embodiment, like effects and profits to those of the first embodiment can be obtained. In addition, it is possible to utilize GPS of very high accuracy, which allows positioning accurate to within several meters, to obtain the latitude and longitude of the two positions, thereby making it possible to identify an image-shooting direction.

As a well-known technique for identifying the direction, Japanese Unexamined Patent Application Publication No. HEI 11-69280 discloses that, in addition to position information received from GPS, direction information is obtained by a geomagnetism-employed direction sensor. Meanwhile, in image data storing system 1B of the second embodiment, both a photographer and a subject of a picture image to be taken carry their own GPS receiver devices 60B and user terminals 30B, in such a manner that the difference in latitude and longitude between the two is used to calculate the direction information. As a result, such a direction sensor as in the above well-known technique is no longer required. In comparison with the geomagnetism-employed direction sensor, which is expensive and requires large-scaled circuits, image data storing system 1B of the present embodiment only needs user terminal 30B and GPS receiver device 60B, thus making it possible to obtain an accurate position information significantly easily with an inexpensive, mobile construction, so that an accurate image-shooting direction can be resultantly obtained.

Further, an image-shooting direction is added to image data, thereby making it possible to provide a user with the information about along which direction (where is being viewed from where) the image data has been obtained.

Still further, photograph information, including background information and site information of a place where image data has been obtained, is determined by the above-described background information designating program, based on the thus obtained image-shooting direction, position information, and geographic data, and the photograph information is then added to the image data. It is thus possible for a user to obtain information about the background of the image data and about the site where the image data has been obtained, which information is useful for classifying/managing the image data, with no need to perform any particular operation.

As in the first embodiment, IDs of the persons who are to be subjects of picture images taken by digital camera 10B are previously registered in ID registering unit 23B. Since only such registered IDs are extracted from IDs having been received so as to be labeled to the image data, it is possible to prevent, with certainty, erroneous labeling of third parties' IDs having no relationship with the image data. There is a possibility that digital camera 10B (GPS receiver device 60B) receives longitude/latitude (position information) from third parties' user terminals. Even in that case, however, digital camera 10B is capable of extracting/selecting, with certainty, only the specific position information (the subject's position information), which has been received from user terminal 30B along with one of the registered IDs that are registered in ID registering unit 23B.

In the above description of the second embodiment, digital camera 10B is connected with image data storage device 20B via a USB. Digital camera 10B and image data storage device 20B may be integrated instead, thereby providing digital camera 10B with the function of image data storage device 20B (the functions of image data storing unit 21B, ID registering unit 23B, image data converter 24B, direction information generator 25B, map database 26B, photograph information generator 27B, and GPS receiver device 60B).

[3] Third Embodiment:

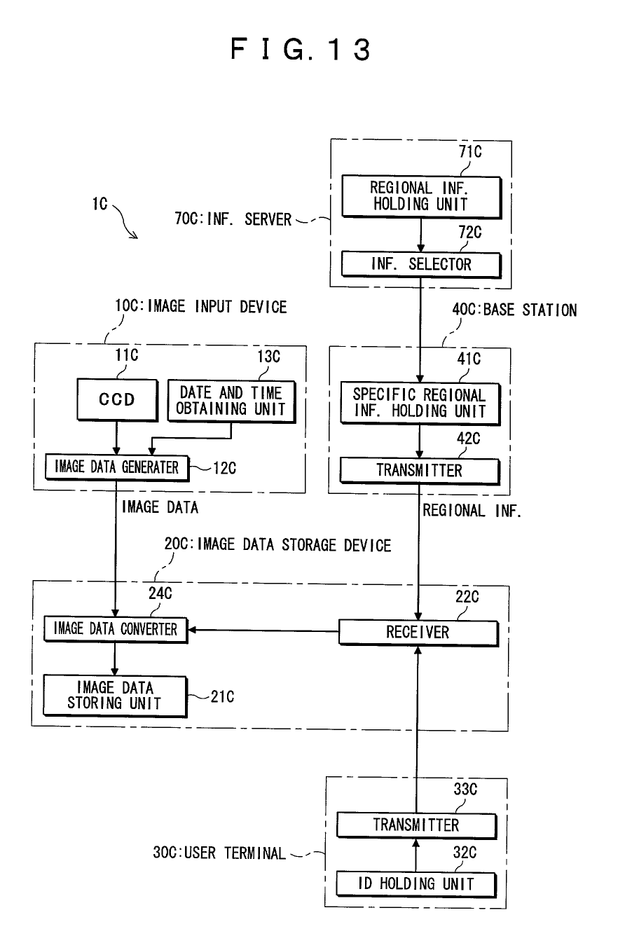

FIG. 13 depicts a construction of an image data storing system of a third embodiment of the present invention. Image data storing system 1C of the third embodiment includes image input device 10C, image data storage device 20C, user terminal 30C, base station 40C, and information server 70C.

Like image input device 10A of the first embodiment, image input device (image obtaining apparatus) 10C, for example, a digital camera carried by a user, generates/obtains image data in response to the user's operations. Image input device (hereinafter called a digital camera) 10C includes CCD 11C, image data generator 12C, and date and time obtaining unit 13C, which carries out like functions to those of CCD 11A, image data generator 12A, and date and time obtaining unit 13A, respectively, and so, detailed descriptions of those elements are omitted here.

User terminal 30C is a mobile terminal carried by a person (user) who is to be a subject of pictures taken by digital camera 10C. User terminal 30C transmits an ID unique to the user, and is realized in use by, for example, a mobile telephone (including a PHS terminal). User terminal 30C includes ID holding unit 32C and transmitter 33C. ID holding unit 32C and transmitter 33C carry out like functions to those of ID holding unit 32A and transmitter 33A, so detailed descriptions are omitted here.

User terminal 30C, as distinct from user terminal 30A of the first embodiment, does not have to be equipped with the function of obtaining position information (for example, the function of receiver 31A of the first embodiment), because the position information about a site where an image has been obtained is received from base station 40C as regional information. Transmitter 33C of the third embodiment serves as a means for transmitting ID information, which transmits IDs (subject information) held in ID holding unit 32 to image data storage device 20C.

Base station 40C serves as a means for transmitting label information (add-on information), which transmits regional information relating to a site at which image data has been obtained (a region where base station 40C is installed) as label information to user (image data storage device 20C). Base station 40C includes specific regional information holding unit 41C, which previously registers and holds regional information relating to the region where base station 40C is installed, and transmitter 42C for sending out the regional information held in specific regional information holding unit 41C.

Here, transmitter 42C, which is realized in practical use by PHS or Bluetooth™, sends out such regional information by wireless toward users who stay inside a limited area. An electronic wave from PHS would travel 100 m from base station 40, while that from Bluetooth™ would travel several to ten-odd meters.

Information server 70C, which has regional information holding unit 71C and information selector 72c, transmits regional information relating to a region where base station 40C is installed to base station 40C so as to register the regional information in specific regional information holding unit 41C. Regional information holding unit 71C previously holds varying items of regional information to be delivered to base stations 40C which are installed in various places. Information selector 72C selects the one of the plural items of regional information in regional information holding unit 71C, which corresponds to the region where base station 40C is installed, so as to transmit the selected information to the corresponding base station 40C.

The regional information stored in regional information holding unit 71C includes advertisement information relating to the sites at which image data is obtained, and also shop/establishment information about one or more shops and/or establishments in the vicinity of the sites. Concrete examples are as follows: names of tourist spots (for example, character strings such as “Nikko Toshogu Shrine”) at which base stations 40C are installed, and data of various types of establishments (overnight accommodations, eating places, tourist attractions, transport facilities, and others) in the vicinity of the tourist spots.

The regional information may be transmitted from information server 70C to base station 40C to be registered/stored previously in specific regional information holding unit 41C. Base station 40C may be connected with information server 70C via a LAN (Local Area Network), so that the regional information stored in specific regional information holding unit 41C is downloaded to base station 40C for updating. The downloading may be carried out in real time, at regular intervals, or upon receipt of a request from information server 70C. Information server 70C is thereby allowed to offer users varying regional information depending upon the time of year (season) or weather, while users are always allowed to receive updated information in real time.

Image data storage device 20C, which is connected with digital camera 10C via a USB cable so as to store image data obtained by digital camera 10C, is carried by a photographer (user) together with digital camera 10C. In use, image data storage device 20C is provided as a hard disc unit, for example, and includes image data storing unit 21C, receiver 22C, and image data converter 24C.

Like image data storing unit 21A, image data storing unit (storage means) 21C, or a hard disc itself, for example, store image data (image file) obtained by digital camera 10C.

Receiver 22C, which is for receiving signals from user terminal 30C and base station 40C, serves as a subject information obtaining means for receiving/obtaining an ID (subject information), which identifies the subject of image data, from user terminal 30C at the time the image data is obtained, and also serves as a label information receiving means (add-on information receiving means) for receiving regional information (position information identifying a place where image data is obtained), which is transmitted from base station 40C in the vicinity of the place where the image data is obtained, at the time the image data is obtained.

Image data converter (information adding means) 24C carries out an image data converting process, in which IDs and regional information, having been received by receiver 22C, are added in the header area of the image data input from digital camera 10C. The resulting converted (or such information-added) image data is stored in image data storing unit 21C. At that time, image data converter 24C, like image data converter 24A of the first embodiment, may extract the IDs, which coincide with those registered in the user table, from IDs having been received and acquired by receiver 22C. Image data converter 24C labels the thus extracted IDs to the image data.

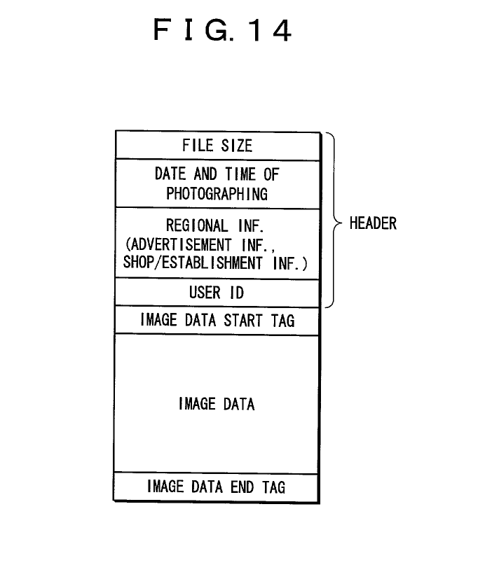

FIG. 14 shows an example of a data structure (format) of digital image data of the third embodiment. As in the first embodiment of FIG. 2, digital image data (image file) stored in image data storing unit 21C of image data storage device 20C is formed of not only an area recording the image data itself but also a header recording various types of information relating to the image data. As shown in FIG. 14, the header stores a file size and the date and time of photographing, as in conventional techniques, and in the third embodiment, there is additionally stored regional information (position information) and also a user ID of a subject of the image data, both of which have been added by image data converter 24C.

A description will be made hereinbelow of an operation of image data storing system 1C of the third embodiment.

In image data storage device 20C of the third embodiment, like that in the first embodiment, receiver 22C receives position information and an ID, both of which are written by image data converter 24C in the header of image data received from digital camera 10C, and the resulting image data is stored in image data storing unit 21C. In the third embodiment, as distinct from the first embodiment, the position information thus labeled to the image data is regional information, which has been transmitted from base station 40C in the vicinity of a place where the image data is obtained.

In addition, in the third embodiment, using a dedicated software tool {image data classification program (described later)} that is capable of reading-in various types of information (the date and time of photographing, IDs, and regional information) labeled in the header of image data, an automatic classification of the image data is realized.

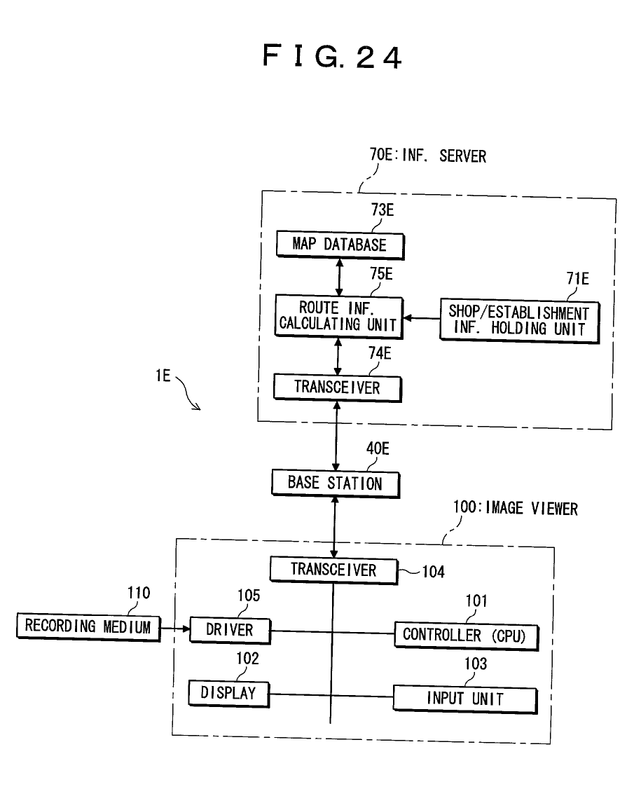

For example, a transmitter (transmitter 42C) that covers a rather small area (for example, to a distance of 100 m or shorter) is equipped to base station 40C previously installed. When a user takes a picture with digital camera 10C, regional information is received from base station 40C, and image data storage device 20C then stores the received regional information in the header of the image data. As described above, the regional information transmitted from base station 40C is, for example, a name of a tourist spot (“Nikko Toshogu Shrine”, or other) in a case where a base station 40C is installed in any tourist spot. The regional information might additionally include other tourist attractions and overnight accommodations in the vicinity of the tourist spot, and also the route to such facilities from the place where the user takes the picture. This regional information is stored in the header of the image data, and a dedicated software tool (for example, a dedicated program to realize image viewer 100 of FIG. 24) renders the information to be shown, together with the image data itself, on a display of a processor device such as a personal computer.

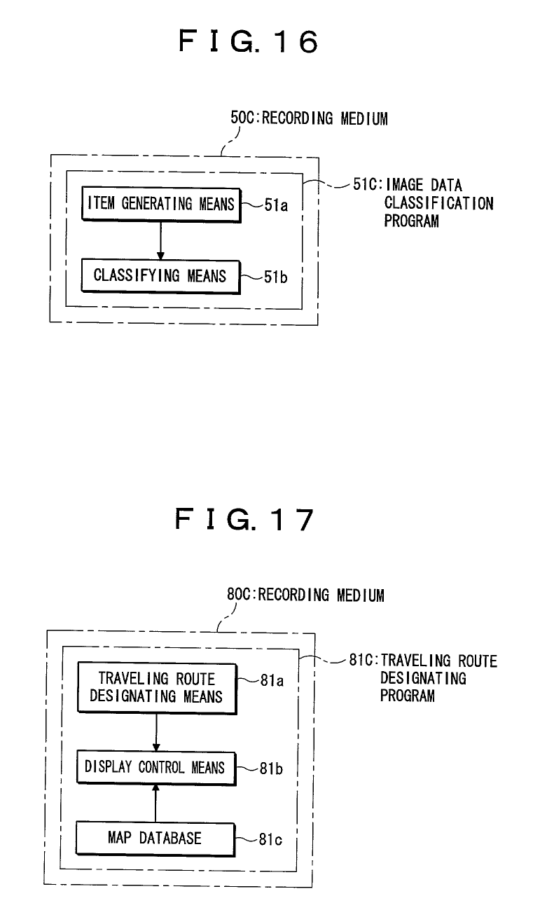

FIG. 16 is a diagram for describing an image data classification program used in the third embodiment. Image data classification program 51C is recorded in a computer-readable recording medium 50C, such as a flexible disc, CD-ROM, and others to be provided to users. The image data classification program may be alternatively recorded in a storage device (recording medium), such as a magnetic disc, optical disc, and magneto-optical disc. In that case, the program is provided from the storage medium to a computer via a communications path.

Image data classification program 51C instructs a processor device, such as a computer, to automatically classify two or more items of image data which image data storage device 20C has labeled with regional information, IDs, and the date and time of photographing. The CPU of the processor device reads out and executes image data classification program 51C previously stored in a ROM in the device, thereby realizing the functions of item generating means 51a and classifying means 51b as follows.

Item generating means 51a generates two or more classification items, according to at least one of regional information, IDs, and the date and time of photographing, all of which are labeled to two or more pieces of image data. Classifying means 51b assigns each of the plural pieces of image data to at least one of the classification items generated by item generating means 51a, based on the regional information, IDs, and the date and time of photographing, labeled to the individual image data.

A detailed description will be made hereinbelow of a technique for automatically classifying image data, realized by image data classification program 51C. Here will be shown an example where the following five pieces of image data, image data 1 through image data 5, which are labeled with date and time of photographing, place at which the image data has been obtained (regional information), and user IDs (participants' information), are subjected to an automatic classification.

Image data 1

Date and Time: Nov. 23, 1999

Place: Nikko Toshogu Shrine

IDs: authorized user (authorized user of digital camera 10C), the user's father, mother, and brother

Image data 2

Date and Time: Nov. 23, 1999

Place: Nikko Toshogu Shrine

IDs: authorized user, the user's father and mother

Image data 3

Date and Time: Nov. 24, 1999

Place: the Kegon-no-taki Falls

IDs: authorized user, the user's father, mother, and brother

Image data 4

Date and Time: Dec. 24, 1999

Place: Minato-Mirai 21

IDs: authorized user and friend A

Image data 5

Date and Time: Jan. 1, 2000

Place: Heian Jingu Shrine

IDs: authorized user

A processor device for executing image data classification program 51C serves as item generating means 51a to automatically generate, for example, the following three classification items: “tour in Nikko”—“Nikko” is a tourist spot in Japan internationally renowned for many historic buildings and other showplaces, and hills of great natural beauty—; “Christmas Eve”; “Hatsumode of the year 2000”—“hatsumode” is a traditional Japanese custom: people go for the first temple or shrine visit of the year and pray for health and happiness in the new year—. Image data classification program 51C serves also as classifying means 51b to assign image data 1, image data 2, and image data 3 to “tour in Nikko”; image data 4, to “Christmas Eve”; image data 5, to “Hatsumode of the year 2000”.

Image data classification program 51C previously assigns position keywords, such as “Nikko Toshogu Shrine”, “Kegon-no-taki Falls”, “Lake Chuzenji-ko” and “Tachiki Kannon” (these are famous tourist attractions in Nikko), to the classification item “Tour in Nikko”, and instructs a processor device (computer) to function in such a way as to assign the pieces of image data, whose dates and times of photographing are in close proximity to each other and whose position keywords agree with the above-mentioned keywords, to the classification item “Tour in Nikko”. Likewise, since image data 4 is obtained on the 24th of December, or Christmas Eve, item generating means 51a automatically generates a classification item “Christmas Eve”, to which image data 4 is then assigned. Since image data 5 is obtained at a shrine on the 1st of January, it is assumed that the data contains a picture image obtained at hatsumode. Item generating means 51a thus creates an item “Hatsumode of the year 2000” to assign the image data 5 thereto.

Since image data 1 through image data 5 store IDs as well as the place where the image data has been obtained and the date and time of photographing, it is possible for image data classification program 51C to carry out the assigning of image data separately for each user (participant). That is, image data classification program 51C automatically generates classification items, “authorized user”, “father”, “mother”, “brother”, and “friend A”, thereby functioning as an item generating means 51a, and also assigns image data 1 through image data 5 to the classification item of “authorized user”; image data 1 through image data 3, to both the classification items of “father” and “mother”; image data 1 and image data 3, to the classification item of “brother”; and image data 4, to the classification item of “friend A”, thereby functioning as classifying means 51b. As a result it is possible for image data classification program 51C to easily create image databases (personal albums), one for each user separately.

Instead of the above-mentioned regional information (the site where the image data has been obtained), latitude and longitude can be labeled to image data, as position information, as shown in the first and second embodiments. In that case, image data classification program 51C instructs a processor device (computer) to function as a place name designating means for designating a place name corresponding to the latitude and longitude according to a map database. In this case, item generating means 51a uses the thus obtained place name to automatically generate classification items in such a manner as described above.

FIG. 17 is a diagram for describing a traveling route designating program. As shown in FIG. 17, traveling route designating program 81C is recorded in a computer-readable recording medium 80C, such as a flexible disc, CD-ROM, and others. The traveling route designating program 81C may be alternatively recorded in a storage device (recording medium), such as a magnetic disc, optical disc, and magneto-optical disc, and in that case, the program is provided from the storage device to a computer via a communications path.

Traveling route designating program 81C instructs a processor device such as a computer to determine a user's traveling route, along which the user has traveled while obtaining a plurality of items of image data at different sites using digital camera 10C. The CPU of the processor device reads out and executes traveling route designating program 81C previously stored in a ROM in the device, thereby realizing the functions of a traveling route designating means 81a and a display control means 81b as follows. Here, traveling route designating program 81C is structured in such a way as to contain map database 81c that stores geographic data.

Traveling route designating means 81a reads out both position information, representing a place where a picture has been taken (a place where image data has been obtained), and the date and time when the picture was taken (the date and time when the image data was obtained), based on both of which the user's traveling route is then determined. Display control means 81b instructs a display of the processor device to display the traveling route determined by traveling route designating means 81a, along with surrounding geographic data read out from map database 81c in such a manner that the traveling route is superimposed over the surrounding geographic data.

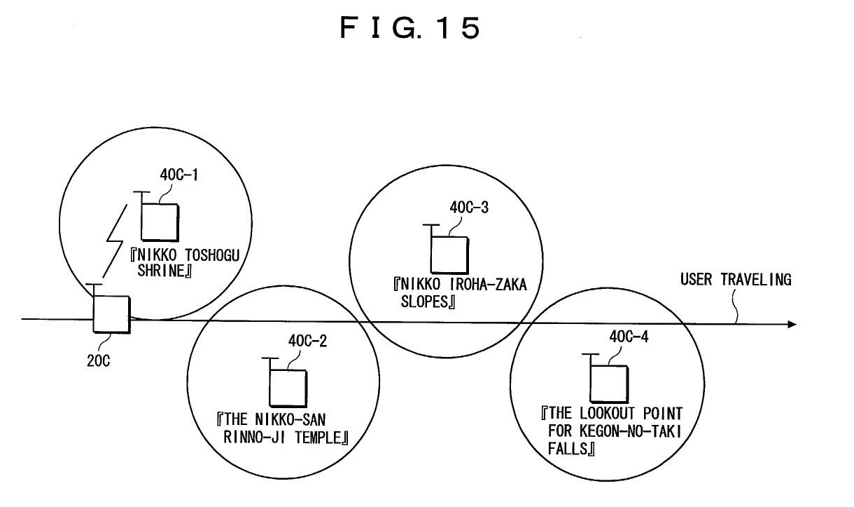

Referring now to FIG. 15, there will be described hereinafter in detail a method for determining a user's traveling route by traveling route designating program 81C. FIG. 15 depicts a procedure carried out by traveling route designating program 81C according to the third embodiment.

In FIG. 15, base stations 40C-1 through 40C-4 perform like functions to those of base station 40C. Specific regional information holding unit 41C equipped to each of base stations 40C-1 through 40C-4 holds regional information corresponding to the place where each of the base stations 40C-1 through 40C-4 is installed, which information (for example, place names such as “Nikko Toshogu Shrine”, “the Nikko-san Rinno-ji Temple”, “Nikko Iroha-zaka Slopes”, and “the lookout point for Kegon-no-taki Falls”) has been registered therein from information server 70C. The circles surrounding base stations 40C-1 through 40C-4 of FIG. 15 indicate areas within which regional information sent out from base stations 40C-1 through 40C-4 can travel.

It is now assumed that a user passes by base stations 40C-1 through 40C-4, while taking pictures in the vicinity of them, and also that the following regional information (the site where the pictures have been taken) is labeled to the image data together with the date and time of photographing (or the date and time of receiving the regional information).

| | |
|---|---|
| 11:35, November 23, 1999 | Nikko Toshogu Shrine |
| 12:42, November 23, 1999 | the Nikko-san |
| | Rinno-ji temple |
| 14:22, November 23, 1999 | Nikko Iroha-zaka |
| | Slopes |
| 15:05, November 23, 1999 | the look out point for |
| | Kegon-no-taki Falls |

At that time, a processor for executing traveling route designating program 81C serves as traveling route designating means 81a to determine that the user visits Nikko Toshogu Shrine, the Nikko-san Rinno-ji temple, Nikko Iroha-zaka Slopes, and the lookout point for Kegon-no-taki Falls, in this sequence. Traveling route designating program 81C then serves as display control means 81b to instruct a display of the processor device to show the determined traveling route along with geographic data of Nikko and its vicinity in such a manner that the traveling route is superimposed over the geographic data from map database 81c.

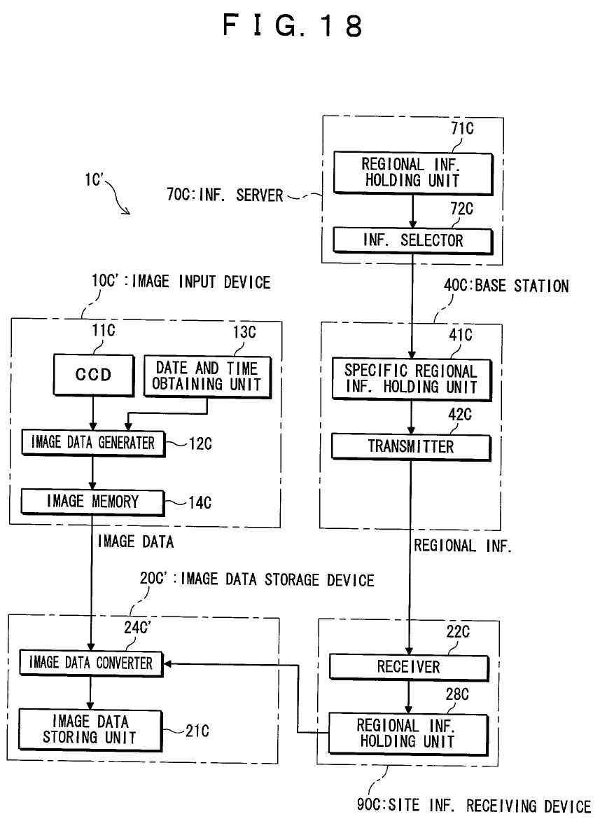

In the above description, traveling route designating program 81C determines and displays a traveling route based on the information labeled to the image data about when and where image data was obtained. Traveling route designating program 81C may also determine such a traveling route based on the following information stored in an information storage device. That is, if the information storage device is adapted to receive regional information from base station 40C (40C-1 through 40C-4), and to accumulate the received regional information and the time of its receipt as a set (see site information receiving device 90C of FIG. 18, for example), traveling route designating program 81C can select an item of route information to be shown on the display, based on both the regional information stored in the information storage device and the time the image was received.

In this manner, since image data storing system 1C of the third embodiment receives regional information (label information/add-on information) sent out in the vicinity of a place where image data is obtained, and then labels the received information to the image data, it is possible to provide a user (a person who takes picture images) with various kinds of information useful to him (for example, advertisement information relating to the place where the image data has been obtained, and shop/establishment information in the vicinity of the place). Accordingly, an information sender (service provider) sends out shop/establishment information as well as company ads and event ads of particular companies and organizations in such a manner that the sent-out information can travel a limited distance to reach the users who are staying in that limited area, so that the service provider can charge the companies, organizations, and shops/establishments for the information transmission.

Additionally, the regional information may be used as position information representing a place where the image data has been obtained. It is thus possible to obtain the position information merely by receiving such regional information, with no need for using any latitude/longitude calculation system such as GPS or any existing positioning service.

At that time, since the regional information contains advertisement information relating to a place where image data has been obtained or information about shops/establishments in the vicinity of the place, the regional information may be useful for users not only as a tool for obtaining position information, as described above, but also as a tool for obtaining the advertisement information and the shop/establishment information.

Further, since data classification program 51C is executed by a computer to automatically classify two or more pieces of image data, which have been labeled with regional information, IDs (subject information), and the date and time of photographing (the date and time when image data of the subject was obtained), into two or more classification items, it is possible to create an image database (a personal album, or the like) separately for each subject of the image data with significant ease.

Still further, the computer executes traveling route designating program 81C to automatically identify a user's traveling route, along which the user has traveled while obtaining a plurality of items of image data at different places, based on a series of image data to which regional information (site information/position information) and the dates and times of photographing have been labeled. The thus identified traveling route will be shown on a display associated with the computer, together with surrounding geographic data.

FIG. 18 depicts a modified example of an image data storing system of the third embodiment. Image data storing system 1C′, as shown in FIG. 18, includes image input device 10C′, image data storage device 20C′, base station 40C, information server 70C, and site information receiving device 90C. In FIG. 18, like reference numbers to those having already been described designate similar parts or elements, so their detailed descriptions are omitted here.

Like image input device 10A of the first embodiment, image input device (image obtaining apparatus) 10C′, for example, a digital camera carried by a user, generates/obtains image data in response to users' operations. Image input device (hereinafter called a digital camera) 10C′ is constructed the same as image input device 10C with the exception that image memory 14C is thoroughly added thereto.

Image memory 14C serves as a means for holding the date and time each item of image data was obtained. It temporarily holds the image data, to which image data generator 12C has labeled the date and time of photographing, before the image data is transferred to image data storage device 20C.

Site information receiving device 90C is carried by a user (photographer) who takes pictures with digital camera 10C′. Site information receiving device 90C includes receiver 22C which is similar to that equipped to image data storage device 20C, and regional information holding unit 28C. In image data storing system 1C′, a user carries site information receiving device 90C, which is reduced in size and weight in comparison with image data storage device 20C. Here, digital camera 10C′ and site information receiving device 90C can be integrated.

Regional information holding unit (regional information holding means) 28C, which is practically provided as a memory such as a RAM, holds regional information (position information), which has been received by receiver 22C from base station 40C, together with the date and time the regional information was received.

Image data storage device 20C′ is connected with digital camera 10C′ via a USB cable or the like to store image data obtained by digital camera 10C′, and is realized in use by a personal computer. Image data storage device 20C′ includes not only image data storing unit 21C, which is similar to that equipped to image data storage device 20C, but also image data converter 24C′. When image data held in image memory 14C of digital camera 10C′ is stored into image data storing unit 21C of image data storage device 20C′, site information receiving device 90C is connected to image data storage device 20C′ via a USB cable or the like to read the regional information and the date and time the regional information was received, both of which are held in regional information holding unit 28C, into image data converter 24C′ of image data storage device 20C′.

Image data converter 24C′ serves as a regional information selecting means. On the basis of the date and time regional information was received, which date and time is read-in from regional information holding unit 28C, and of the date and time of photographing (date and time when image data was obtained) labeled to image data received from digital camera 10C′, image data converter 24C′ selects one item of regional information, whose date and time of receipt corresponds to the date and time of photographing labeled to the image data, among plural items of regional information held in regional information holding unit 28C. Image data converter 24C′ then carries out an image data conversion process, in which the regional information, thus selected by the above-mentioned function as the regional information selecting means, is added into the header of the image data received from digital camera 10C′, as position information. After the conversion, the converted image data, or the label information-added image data, is stored in image data storing unit 21C.

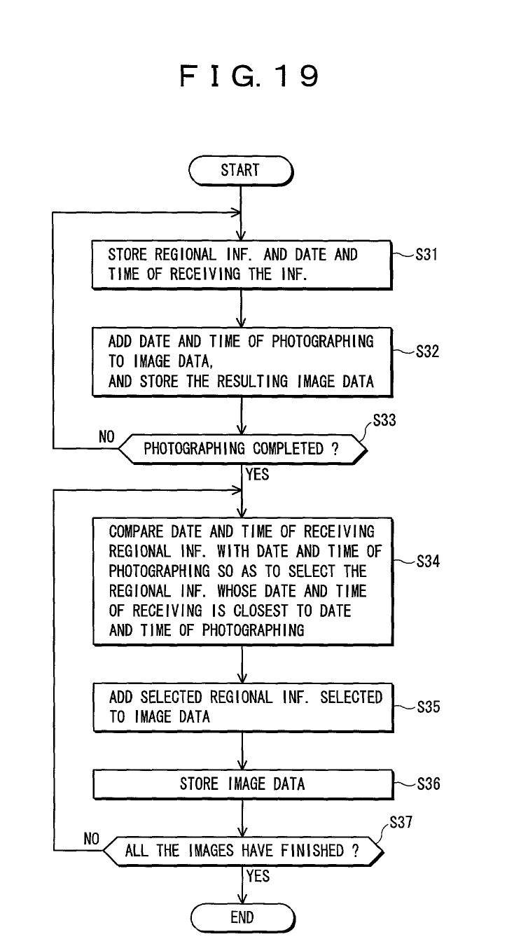

In accordance with the flowchart (step S31 through step S37) of FIG. 19, a description will be made hereinbelow of a procedure executed by image data storing system 1C′ of a modified example of the third embodiment.

Here, consideration should be given to a probable time lag between when image data is obtained and when the image data is stored. For example, there should be considered a case where image data is stored in image memory 14C of digital camera 10C′, and afterward, the image data is stored in image data storage device 20C′ (personal computer, or the like). Generally speaking, because image memory (nonvolatile memory medium) 14C built in digital camera 10C′ has a small capacity for its high price, it is necessary to move the image data being temporarily held in image memory 14C to image data storing unit 21C, which serves as an external recording medium having a great amount of capacity. As a result, a time lag would be caused between when the image data is obtained and when the image data is stored into the recording medium.

Upon receipt of regional information from base station 40C, site information receiving device 90C, which is being carried by a photographer, stores the received regional information and the date and time of receipt, in association with one another, in regional information holding unit 28C (step S31).

If a photographer obtains image data with digital camera 10C′, date and time obtaining unit 13C acquires the date and time the image data was obtained, which date and time is then added by image data generator 12C into the header of the image data input from CCD 11C. The image data thus labeled with the date and time is then temporarily held in image memory 14C (step S32).

The procedure of step S31 and step S32 will be repeated until digital camera 10C′ finishes photographing (YES route of S33).

When the image data in image memory 14C is stored into image data storage device 20C′, both digital camera 10C′ and site information receiving device 90C are connected to image data storage device 20C′.

Image data converter 24C′ then compares the date and time of obtaining the image data, which was labeled to the image data when the image data was obtained, with the dates and times of receipt of plural items of regional information in regional information holding unit 28C, in order to select the most appropriate regional information (that whose date and time of receipt is closest to the date and time of obtaining the image data) as position information. The selected regional information is read out from regional information holding unit 28C (step S34).

After that, image data converter 24C′ writes the regional information selected in step S34 into the header of the image data received from digital camera 10C′ (step S35), and then stores the image data in image data storing unit 21B (step S36).

The procedure from step S34 through step S36 will be repeated until the procedure is executed on all the image data to be stored from digital camera 10C′ to image data storage device 20C′ (YES route of S37).

In this manner, with image data storing system 1C′ of a modified example of the third embodiment, even if the above-mentioned time lag should occur, it is still possible to label the image data with the most appropriate regional information having been received in the vicinity of the place where the image data was obtained, that is, with an accurate item of position information corresponding to where the image data has been obtained.

In this instance, in image data storing system 1C′, receiver 22C of site information receiving device 90C may receive and obtain IDs (subject information) of the subjects of the image data from user terminal 30C (see FIG. 13) that are being carried by users who are the subjects of the image data. The IDs are stored in a memory together with the date and time the IDs were received. As a result, when the image data obtained by digital camera 10C′ is stored in image data storing unit 21C, it is possible to read-out the IDs corresponding to the date and time the image data was obtained, from the memory to store them in the header of the image data.

[4] Fourth Embodiment:

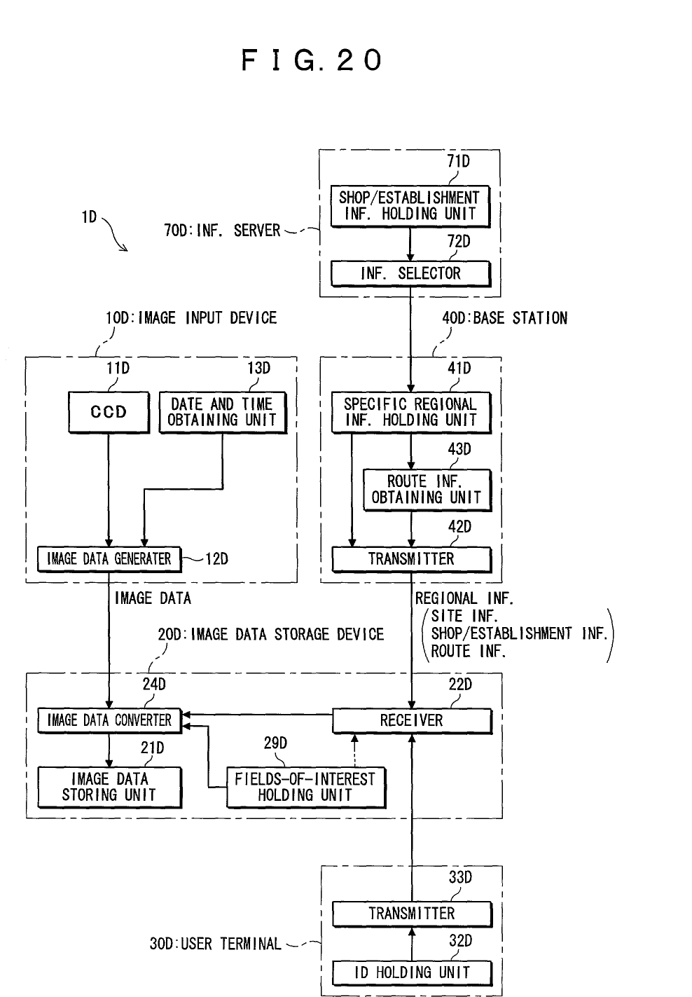

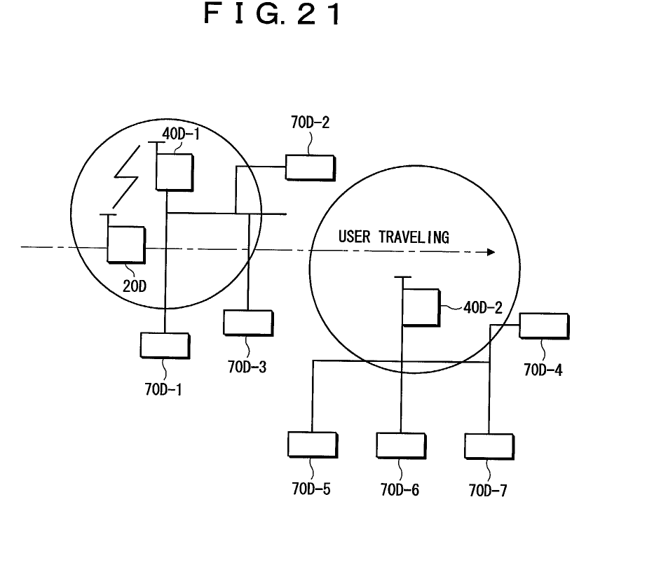

FIG. 20 depicts a construction of an image data storing system of a fourth embodiment of the present invention. FIG. 21 depicts an overview of an image data storing system of the fourth embodiment.

Image data storing system 1D of the fourth embodiment includes image input device 10D, image data storage device 20D, user terminal 30D, base station 40D, and information server 70D.

Like image input device 10A of the first embodiment, image input device (image obtaining apparatus) 10D, for example, a digital camera carried by a user, generates/obtains image data in response to users' operations. Image input device (hereinafter called a digital camera) 10D also includes CCD 11D, image data generator 12D, and date and time obtaining unit 13D, which carry out like functions to those of CCD 11A, image data generator 12A, and date and time obtaining unit 13A, respectively, and so, detailed descriptions of those elements are omitted here.

User terminal 30D, like user terminal 30C of the third embodiment, is a mobile terminal carried by a person (user), who is to be a subject of pictures taken by digital camera 10D. User terminal 30D transmits an ID unique to the user, and is realized in use by, for example, a mobile telephone (including a PHS terminal). User terminal 30D includes ID holding unit 32D and transmitter 33D. ID holding unit 32D and transmitter 33D carry out like functions to those of ID holding unit 32C and transmitter 33C of the third embodiment. So, their detailed descriptions are omitted here.

Base station 40D serves as a means for transmitting label information, which transmits regional information relating to a site at which image data has been obtained (a region where base station 40D is installed) as label information, to user (image data storage device 20D). As distinct from the other embodiments, in the fourth embodiment, the regional information contains shops/establishment information in the vicinity of where the image data was obtained. Base station 40D of the fourth embodiment includes specific regional information holding unit 41D, transmitter 42D and route information obtaining unit 43D.

Specific regional information holding unit 41D previously registers shop/establishment information about shops and/or establishments in the vicinity of a place where specific regional information holding unit 41D is installed, as regional information. Like the third embodiment, the regional information includes not only such shop/establishment information but also a place name (the name of the tourist spot where the specific regional information holding unit 41D is installed) which is to be used in an automatic classification of image data. More precisely, regional information of the present embodiment contains not only a concrete place name, such as “Nikko Toshogu Shrine”, as positional information but also information about shops and other establishments located within a predetermined distance apart from base station 40D (this information is called “shop/establishment information” in the present description). More precisely, regional information about “Nikko Toshogu Shrine” includes shops/establishment information, such as overnight accommodations and tourist attractions (for example, “the XXX Hotel”, “the XXX Museum”, and others) neighboring the Shrine.

Transmitter 42D transmits the regional information, including the shop/establishment information, stored in specific regional information holding unit 41D, together with route information (described later) obtained by route information obtaining unit 43D. Transmitter 42D, like transmitter 42C, transmits shop/establishment information by wireless to users who are staying in a limited area, and is realized in use by a PHS or Bluetooth™.

Route information obtaining unit (route information obtaining means) 43D, at transmission of the regional information, obtains route information about a traveling route (access) from the site at which base station 40D is installed, or where the image data has been obtained, to the shops and establishments contained in the regional information, and then adds the route information to the regional information. A concrete example of this route information is, for example, “five minutes' walk from the entrance approach to Nikko Toshogu Shrine; in front of the bus stop of XX”. Route information obtaining unit 43D has a traveling route holding means for previously holding varying point-to-point traveling routes on geographic data, and also has a traveling route selecting means for selecting, among the above-described varying traveling routes, the route information about a traveling route from base station 40D (the site at which the image data has been obtained) to an intended shop or establishment. In this instance, if the shop/establishment information stored in specific regional information holding unit 41D includes the above-mentioned route information, it would no longer be necessary for route information obtaining unit 43D to be provided separately.

Information server (shop/establishment server) 70D, which includes shop/establishment information holding unit 71D and information selector 72D, transmits shop/establishment information relating to a region in which base station 40D is installed to base station 40D, so as to register the shop/establishment information in specific regional information holding unit 41D. Shop/establishment information holding unit 71D previously holds various items of shop/establishment information to be delivered to base stations 40D installed in various regions. Information selector 72D selects the one, which corresponds to the location of each base station 40D, of the items of shop/establishment information held in regional information holding unit 71D, and then transmits the selected shop/establishment information to the corresponding base station 40C.

Although image data storing system 1D of FIG. 20 has only one information server 70D that manages plural items of shop/establishment information in an integrated way, plural information servers (shop/establishment servers) 70D-1 through 70D-7, one for each shop or establishment, may be prepared instead, as shown in FIG. 21. In this case, base stations (add-on information transmitting means) 40D-1, 40D-2, which have the same construction as that of the above-mentioned base station 40D and are installed in different regions, are communicably connected with information servers 70D-1 through 70D-7 via a communications network, so that the shop/establishment information is sent out through base stations 40D-1, 40D-2. In FIG. 21, base station 40D-1 is connected with neighboring shop/establishment servers 70D-1 through 70D-3; base station 40D-2, with neighboring shop/establishment servers 70D-4 through 70D-7. Otherwise, all the base stations 40D-1, 40D-2 and all the information servers 70D-1 through 70D-7 may be connected via one and the same communications network in such a manner that a hub selects an appropriate one of the information servers 70D-1 through 70D-7 to connect to base stations 40D-1, 40D-2. As a result, even if shop/establishment information is required to be sent out from two or more base stations, the information to be transmitted from each base station may be controlled with ease by changing the setting of the hub. In FIG. 21, the circles surrounding base stations 40D-1, 40D-2 indicate the ranges within which the regional information transmitted by base stations 40D-1, 40D-2, respectively, could reach.

Image data storage device 20D, which is connected with digital camera 10D via a USB cable so as to store image data obtained by digital camera 10D, is carried by a photographer (user) together with digital camera 10D. In use, image data storage device 20D is provided as a hard disc unit, for example, and includes image data storing unit 21D, receiver 22D, image data converter 24D, and fields-of-interest holding unit 29D.

Like image data storing unit 21A, image data storing unit (storage means) 21D is, for example, a hard disc itself, and stores image data (image file) obtained by digital camera 10D.

Receiver 22D, which receives signals from user terminal 30D and base station 40D, serves as a subject information obtaining means for receiving/obtaining subject information (ID), which identifies a subject of image data, from user terminal 30D at the time the image data is obtained. Receiver 22D also serves as a label information receiving means for receiving regional information (including position information, shop/establishment information, and route information), which is transmitted from base station 40D located in the vicinity of the place where the image data has been obtained, at the time of obtaining the image data.

Fields-of-interest holding unit (add-on-information-kind holding means) 29D previously registers the kind of shop/establishment information (label information/add-on information), which is previously registered as demands of a user of image data storage device 20D (digital camera 10D), that is, the fields which the user is interested in.

Image data converter (information adding means) 24D, like image data converter 24A of the first embodiment, carries out an image data conversion process, in which IDs and regional information, having been received by receiver 22D, are added in the header area of the image data input from digital camera 10D. The resulting converted (or such information-added) image data is stored in image data storing unit 21D.

At that time, image data converter 24D serves as a label information extracting means (add-on information extracting means) for extracting the items of label information that match the kind of information held in fields-of-interest holding unit 29D, from the plural items of shop/establishment information included in the regional information which is received by receiver 22D. Image data converter 24D labels the regional information that includes the thus extracted shop/establishment information and route information relating to the shop/establishment information, to the obtained image data, along with IDs. At that time, the function of the above-mentioned label information extracting means may be equipped to receiver 22D, not to image data converter 24D, so that receiver 22D refuses the shop/establishment information and the route information which do not match the user's fields of interest registered in fields-of-interest holding unit 29D.

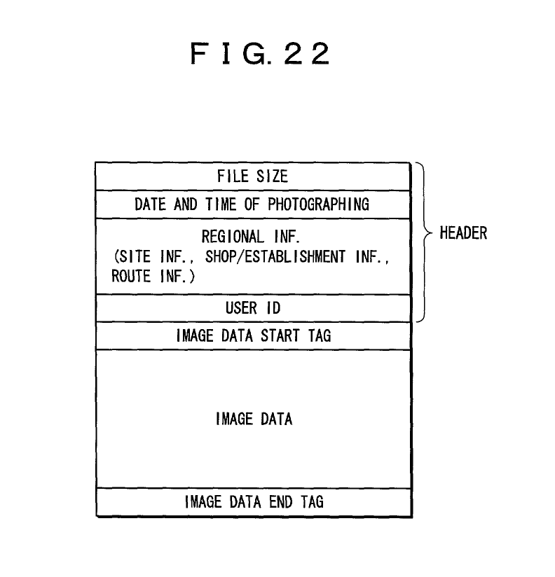

FIG. 22 shows an example of a data structure (format) of digital image data of the fourth embodiment. As in the first embodiment of FIG. 2, digital image data (image file) stored in image data storing unit 21D of image data storage device 20D is formed of not only an area recording the image data itself but also a header recording various types of information relating to the image data. As shown in FIG. 22, the header stores a file size and the date and time the image data was obtained, as in conventional techniques. In the fourth embodiment, additionally, there is stored regional information that includes position information, shop/establishment information, and route information, and also a user ID of a subject of the image data, both of which have been added by image data converter 24D.

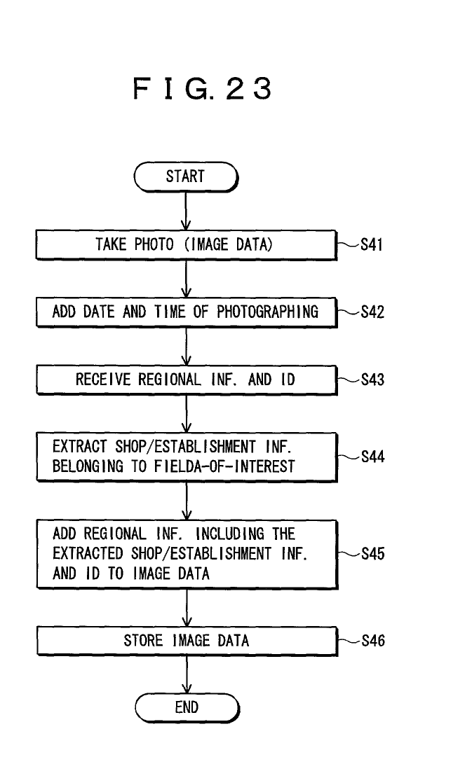

In accordance with the flowchart (step S41 through step S46) of FIG. 23, a description will be made hereinbelow of a procedure executed by image data storing system 1D of the fourth embodiment.

If a photographer takes a picture of a person (subject), who is carrying user terminal 30D, with digital camera 10D (step S41), date and time obtaining unit 13D obtains the date and time of photographing, which is then added by image data generator 12D into the header of the image data input from CCD 11D (step S42). The image data thus labeled with the date and time of photographing is then input from digital camera 10D to image data storage device 20D via a USB or the like.

At that time, in image data storage device 20D, receiver 22D receives/obtains the subject person's (user's) ID (subject information), which is unique to the user, from user terminal 30D carried by the user, and also receives/obtains regional information containing position information, shop/establishment information, and route information, from base station 40D (step S43).

Among plural items of shop/establishment information included in the thus received regional information, image data converter 24D extracts those whose types match the user's fields of interest (information kinds) having been registered previously in fields-of-interest holding unit 29D, and any other items of shop/establishment information and relevant information are abandoned (step S44).

After that, image data converter 24D then writes both the position information and the regional information containing the shop/establishment information and route information, which have been extracted in step S44, into the header of the image data received from digital camera 10D (step S45). The image data is then stored in image data storing unit 21D (step S46).

In the above description, the extracting/selecting of the information is carried out on image data storage device 20D side as demanded by the user. Otherwise, base station 40D may transmit only the shop/establishment information that matches the user's demand. In this case, for example, image data storage device 20D sends information about what fields the user is interested in to base station 40D, and then, base station 40D sends back the shop/establishment information that matches the user's fields of interests received from image data storage device 20D, to image data storage device 20D.

Here, consideration should be given to a case where base station 40D sends out shop/establishment information relevant to various kinds of shops and facilities. In such a case, there is a danger that the information might contain shop/establishment information useless to a user. If such useless shop/establishment information, which the user is not interested in at all, was added to image data, it would be irritating for the user. In view of this, in the fourth embodiment, the fields (information kind) in which a user is interested in are previously registered in such a manner that only the shop/establishment information that belongs to those fields can be extracted, so that only such useful information be stored in the header of image data. As good examples, the following fields could be set: “overnight accommodations”; “eating places”; “souvenir shops”; “bars”; and “tourist attractions”.

More precisely, class numbers are given, one for every field of interest, and every item of shop/establishment information is labeled with such a class number. Additionally, fields-of-interest holding unit 29D registers the class numbers of the fields which a user is interested in. Hence, if an item of shop/establishment information whose class number is not registered in fields-of-interest holding unit 29D is received, the shop/establishment information is either refused or abandoned.

Because regional information can travel only a limited distance from base station 40D in image data storing system 1D of the fourth embodiment, as shown in FIG. 21, the current position of image data storage device 20D could be regarded as identical to the location of base station 40D. If image data is labeled with not only shop/establishment information about a shop or establishment but also with route information about a traveling route from base station 40D to the shop or establishment, it is possible to show a user the way to the shop or establishment from where the image data has been obtained.

In this manner, with image data storing system 1D of the fourth embodiment, it would be possible for companies to label their advertisements as shop/establishment information, to image data that tourists can obtain. A service provider, which provides such shop/establishment information, can charge the companies for transmission and storage (labeling) of such advertisement, depending upon, for example, the number of times transmission is carried out.

Meanwhile, digital image data is advantageous in that it is easy to duplicate and transfer. It is thus possible for a user to store such digital image data in a recording medium or to attach the data to an e-mail, so that the image data can be delivered to third parties. It is expected that the image data be delivered to a user's family members and friends through the user's personal network, so that the shop/establishment information stored therein is also delivered through the network. As a result, advertising companies could expect that their advertisements be delivered not only to the user himself but also to the user's family members and friends, at no additional cost for the secondary delivery.

At that time, it is possible to select only the shop/establishment information that is useful to a user (for example, the shop/establishment information of the fields the user is interested in), among various kinds of shop/establishment information, to add to the image data to be provided to the user. In addition, the way to the shop or establishment from the place where the image data was obtained can be always shown as route information. It is thus possible to show a user the way to the shop/establishment, not only at the time the image data was actually obtained but also at the time the user revisits the place where the image data was obtained, thereby making the shop/establishment more appealing to the user.

[5] Fifth Embodiment:

FIG. 24 depicts a construction of a browsing system of a fifth embodiment of the present invention. Browsing system 1E of the fifth embodiment includes base station 40E, information server 70E, and image viewer 100.

Image viewer (image data browsing means) 100 displays image data, which is stored in image data storing system 1D of the fourth embodiment, along with regional information (shop/establishment information and route information) labeled to the image data. Image viewer 100 is realized in practical use by a mobile processor device, such as a notebook computer, which activates/executes a certain program. Image viewer 100 thus includes controller (CPU) 101, display 102, input unit (keyboard, mouse) 103, transceiver (modem) 104, and driver 105, in the same way that processor devices in common use do.

When image data is browsed on display 102 of image viewer 100, the image data to which regional information has been added by image data storing system 1D is input to image viewer 100. When the image data is input to image viewer 100, recording medium 110 recording the image data is placed in driver 105 to read out the image data therefrom, or the image data may otherwise be received from an external apparatus through transceiver 104. Recording medium 110 is, for example, a CD-ROM or a flexible disc.

Base station 40E is the one which is located closest to image viewer 100, and is connected with information server 70E via a communications network. Image viewer 100 has transceiver 104, which receives/transmits data from/to information server 70E via base station 40E.

Information server 70E includes shop/establishment information holding unit 71E, map database 73E, transceiver 74E, and route information calculating unit 75E.

Shop/establishment information holding unit 71E previously holds shop/establishment information (locations of shops and establishments) to be labeled to image data by image data storing system 1D. Though shop/establishment information holding unit 71E is equipped to information server 70E in this example, it may alternatively be included in a shop/establishment server (not shown) installed in every shop or establishment. In this case, such a shop/establishment server and information server 70E are communicably connected via a communications network, so that information server 70E can access shop/establishment information holding unit 71E of each shop/establishment server.

Map database 73E previously stores geographic data containing at least locations of shops/establishments and base station 40E.

Transceiver 74E receives/transmits data from/to image viewer 100 via base station 40E. Transceiver 74E serves both as a means for obtaining browsing-place information which identifies a place where image data is to be browsed (the current position of image viewer 100) by image viewer 100 and as a means for notifying image viewer 100 of the obtained route information (described later) to be displayed thereon. In the present embodiment, it is assumed that the current position of image viewer 100 is identical to the location of base station 40E, and hence the means for obtaining browsing-place information obtains/identifies the location of base station 40E as the current position of image viewer 100.

Route information calculating unit (route information obtaining means) 75E obtains route information about a traveling route from the place identified by the means for obtaining browsing-place information to a shop/establishment corresponding to the shop/establishment information requested by image viewer 100. Route information calculating unit 75E, like route information obtaining unit 43D of the fourth embodiment, has a traveling route holding means for previously holding varying point-to-point traveling routes on geographic data, and also has a traveling route selecting means for selecting, among the above-described varying traveling routes, the route information about a traveling route from base station 40E (the current position of image viewer 100) to an intended shop or establishment. Here, route information calculating unit 75E obtains the position of a requested shop/establishment from shop/establishment information holding unit 71E.

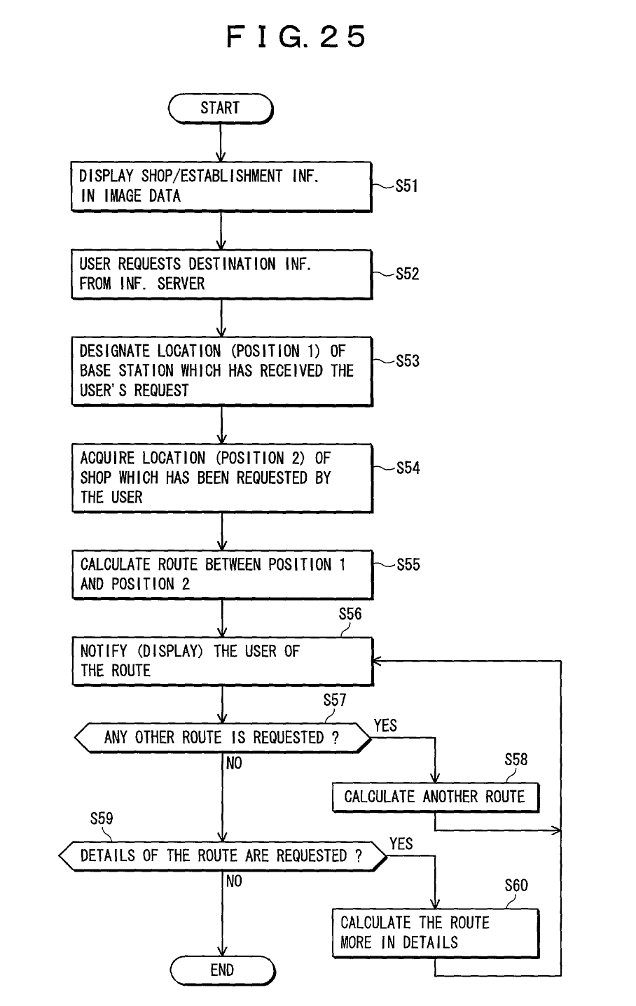

In accordance with the flowchart (step S51 through step S60) of FIG. 25, a description will be made hereinbelow of a procedure executed by image data storing system 1E of the fifth embodiment.

In the fourth embodiment, route information to be labeled to image data by image data storing system 1D was, for example, “five minutes' walk from the entrance approach to Nikko Toshogu Shrine; in front of the bus stop of XX”. The reference point of this route information is the site where the image data has been obtained, that is, “the entrance approach to Nikko Toshogu Shrine”. Generally speaking, however, the browsing of image data and route information is often carried out anywhere else than the place at which the image data has been actually obtained. In that case, even if route information from the place where the image data has been obtained to an intended shop/establishment is displayed, it would often be of no use. From a user's viewpoint, if route information about a traveling route from the place where the image data is now being browsed to an intended shop/establishment is displayed, it would be more convenient. In view of this matter, image data storing system 1E of the fifth embodiment makes it possible for a user, while he is browsing the image data, to obtain route information (access) about a traveling route from the place where the image data is being browsed (the user's current position) to an intended shop/establishment.

In image viewer 100, image data read-out from recording medium 110 and image data received from an external apparatus via transceiver 104 are shown on display 102. At that time, shop/establishment information labeled to the image data is also displayed at the same time (step S51). If a user who is browsing the information of a shop or establishment wishes to know the way from his present position to the shop or establishment, the user makes a request to information server 70E for route information (destination information) through input unit 103 (step S52). This request for the route information is transmitted to information server 70E via a base station 40E that is located closest to the image viewer 100.

Information server 70E identifies the location (position 1) of the base station 40E that has received the user's request, as the user's current position (step S53), and obtains the location (position 2) of the shop/establishment requested by the user from shop/establishment information holding unit 71E (step S54).

After that, route information calculating unit 75E calculates/selects a route from the above-mentioned position 1 to position 2 (step S55), and the thus obtained route is notified from transceiver 74E of information server 70E to image viewer 100 via base station 40E, as route information, and is then shown on display 102 (step S56).

With reference to the displayed route information, the user decides whether to request another route (step S57). If the user makes a request for another route through input unit 103 (YES route of step S57), the request is notified to information server 70E via base station 40E, information server 70E calculates another route (step S58), and the procedure returns to step S56.

If the user does not request another route (NO route of step S57), the user then decides whether to request the details of the route that has been notified in step S56 (step S59). If the user makes such a request through input unit 103 (YES route of step S59), the request is then notified to information server 70E via base station 40E, information server 70E calculates the route more in detail (step S60), and the procedure returns to step S56. Otherwise, if the user does not request the details of the route (NO route of step S59), the procedure ends.

In this manner, with browsing system 1E of the fifth embodiment, since image data stored by image data storing systems 1A through 1D, and 1C′ of the first through fourth embodiments, respectively, is displayed on image viewer 100 together with various types of information labeled to the image data, it is possible for a user to use image viewer 100 to browse the image data and various types of information labeled thereto.

In particular, in browsing system 1E of the fifth embodiment, a user can obtain a route from the place at which the user is now browsing shop/establishment information to the shop or establishment that is shown on image viewer 100. Since image viewer 100 displays the way to the shop or establishment from where the user is now, the user can access the shop or establishment very easily, thereby making the shop/establishment more appealing to the user.

[6] Various Other Modifications:

The present invention should by no means be limited to the above-illustrated embodiments, and various changes or modifications may be suggested without departing from the gist of the invention.

For example, in the first through fourth embodiments, a digital camera, 10A through 10D, is provided as separate equipment from an image data storage device, 20A through 20D, and all the functions equipped to the image data storage device, 20A through 20D, may be given to the digital camera, 10A through 10D, instead, so that the digital camera, 10A through 10D, and the image data storage device, 20A through 20D, are integrated into one device.

What is claimed is:

1. An image data storing system, comprising:
(a) an image obtaining apparatus for obtaining image data of a subject;
(b) storage means for storing the image data, which has been obtained by said image obtaining apparatus;
(c) means for obtaining site information representing a site at which said image data has been obtained by said image data obtaining apparatus;
(d) means for obtaining subject information identifying the subject of said image data; and
(e) information adding means for adding both said site information and said subject information to said image data, which is to be stored into said storage means.

2. An image data storing system according to claim 1, wherein said image obtaining apparatus comprises:
(a-1) means for obtaining date and time when said image data of the subject is obtained; and
(a-2) means for adding said date and time when said image data of the subject is obtained to said image data.

3. An image data storing system according to claim 1, further comprising means for calculating an image-shooting direction, in which shooting of an image of a subject has been carried out by said image obtaining apparatus, based on both first position information, representing a position in which said image obtaining apparatus is located, and second position information, representing a position in which the subject of said image data is located, both of said first position information and said second position information being obtained by said site information obtaining means, as said site information, when said image data of the subject has been obtained,
said information adding means being operable to add the calculated image-shooting direction to said image data, which is to be stored into said storage means.

4. An image data storing system according to claim 2, further comprising means for calculating an image-shooting direction, in which shooting of an image of a subject has been carried out by said image obtaining apparatus, based on both first position information, representing a position in which said image obtaining apparatus is located, and second position information, representing a position in which the subject of said image data is located, both of said first position information and said second position information being obtained by said site information obtaining means, as said site information, when said image data of the subject has been obtained,
said information adding means being operable to add the calculated image-shooting direction to said image data, which is to be stored into said storage means.

5. An image data storing system according to claim 1, further comprising:
means for calculating an image-shooting direction, in which shooting of an image of a subject has been carried out by said image obtaining apparatus, based on both first position information, representing a position in which said image obtaining apparatus is located, and second position information, representing a position in which the subject of said image data is located, when said image data of the subject is obtained, both of said first position information and said second position information being obtained by said site information obtaining means, as said site information, when said image data of the subject has been obtained;
a map database holding geographic data; and
means for identifying a background subject, which has presumably dominated the background of said image data, as background information, based on said image-shooting direction, said site information, and said geographic data,
said information adding means being operable to add said background information to said image data, which is to be stored into said storage means.

6. An image data storing system according to claim 2, further comprising:
means for calculating an image-shooting direction, in which shooting of an image of a subject has been carried out by said image obtaining apparatus, based on both first position information, representing a position in which said image obtaining apparatus is located, and second position information, representing a position in which the subject of said image data is located, when said image data of the subject is obtained, both of said first position information and said second position information being obtained by said site information obtaining means, as said site information, when said image data of the subject has been obtained;
a map database holding geographic data; and
means for identifying a background subject, which has presumably dominated the background of said image data, as background information, based on said image-shooting direction, said site information, and said geographic data,
said information adding means being operable to adding said background information to said image data, which is to be stored into said storage means.

7. An image data storing system according to claim 2, further comprising:
means for transmitting add-on information; and
means for receiving said add-on information from said add-on information transmitting means in the vicinity of the site at which said image data of the subject has been obtained,
said information adding means being operable to add said add-on information received by said add-on information receiving means to said image data, which is to be stored into said storage means.

8. An image data storing system according to claim 7, wherein:
said add-on information is regional information relating to a site at which said image data is obtained; and
said site information obtaining means serves also as said add-on information receiving means to receive and obtain said regional information as said site information.

9. An image data storing system according to claim 8, further comprising:
means for holding date and time when each of a plurality items of said image data has been obtained;
means for holding a plurality of items of said regional information, which have been obtained as said site information, along with date and time when each of the plural items of said regional information has been received; and
means for selecting one item, whose date and time of receipt corresponds to the date and time of obtaining, among the plural items of said regional information held in said regional information holding means, based on both said date and time of obtaining and said date and time of receipt;
said information adding means being operable to add the selected one item of regional information to said image data as said site information.

10. An image data storing system according to claim 8, wherein said regional information includes advertisement information relating to the site at which said image data has been obtained.

11. An image data storing system according to claim 7, wherein said regional information includes shop/establishment information about one or more shops and/or establishments in the vicinity of the site at which said image data has been obtained.

12. An image data storing system according to claim 11, further comprising means for obtaining route information about a traveling route from the site at which said image data has been obtained to an intended individual shop or establishment;
said information adding means being operable to add said route information to said image data, which is to be stored into said storage means.

13. An image data storing system according to claim 1, further comprising means for browsing said image data, which is stored in said storage means, along with add-on information added to said image data by said information adding means.

14. An image data storing system according to claim 11, further comprising:
browsing means for displaying said image data, which is stored in said storage means, along with said shop/establishment information to browse;
means for obtaining browsing-place information which identifies a place where said image data is to be browsed by said browsing means;
means for obtaining route information about a traveling route from said place identified by the obtained browsing-place information to an intended individual browsing place whose information has been displayed on said browsing means; and
means for notifying said browsing means of the obtained route information to be displayed thereon.

15. An image data storing system according to claim 7, further comprising:
means for holding the kind of said add-on information, which is previously registered as the user's demand;
means for extracting an item of add-on information, whose kind coincides with said information kind held in said add-on-information-kind holding means, from the plural items of said add-on information received by said add-on information receiving means,
said information adding means being operable to add said add-on information, which has been extracted by said add-on information extracting means, to said image data.

16. An image data storing system according to claim 8, further comprising:
means for holding the kind of said add-on information, which is previously registered as the user's demand;
means for extracting an item of add-on information, whose kind coincides with said information kind held in said add-on-information-kind holding means, from the plural items of said add-on information received by said add-on information receiving means,
said information adding means being operable to add said add-on information, which has been extracted by said add-on information extracting means, to said image data with.

17. An image data storing system according to claim 11, further comprising:
means for holding the kind of said add-on information, which is previously registered as the user's demand;
means for extracting an item of add-on information, whose kind coincides with said information kind held in said add-on-information-kind holding means, from the plural items of said add-on information received by said add-on information receiving means,
said information adding means being operable to add said add-on information, which has been extracted by said add-on information extracting means, to said image data.

18. An image data storing system according to claim 13, further comprising:
means for holding the kind of said add-on information, which is previously registered as the user's demand;
means for extracting an item of add-on information, whose kind coincides with said information kind held in said add-on-information-kind holding means, from the plural items of said add-on information received by said add-on information receiving means,
said information adding means being operable to add said add-on information, which has been extracted by said add-on information extracting means, to said image data with.

19. An image data storing system according to claim 14, further comprising:
means for holding the kind of said add-on information, which is previously registered as the user's demand;
means for extracting an item of add-on information, whose kind coincides with said information kind held in said add-on-information-kind holding means, from the plural items of said add-on information received by said add-on information receiving means,
said information adding means being operable to add said add-on information, which has been extracted by said add-on information extracting means, to said image data.

20. An image data storing system according to claim 1, further comprising at least one mobile terminal, which is to be carried by a user who is the subject of said image data, for transmitting identification (ID) information identifying the user,
said subject information obtaining means being operable to receive said ID information from said mobile terminal, as said subject information, when said image data is obtained.

21. An image data storing system according to claim 20, further comprising:
means for registering a plurality of IDs of a plurality of users whose respective image data might be obtained by said image obtaining apparatus; and
means for extracting a user ID, which coincides with one of the user IDs held in said ID registering means, from said ID information obtained by said subject information obtaining means;
said information adding means being operable to add the extracted user ID to said image data.

22. An image data storing system according to claim 20, wherein said mobile terminal is a mobile telephone.

23. An image data storing system according to claim 21, wherein said mobile terminal is a mobile telephone.

24. An image data storing system according to claim 1, wherein said site information obtaining means obtains latitude and longitude of the site at which said image data has been obtained, as said site information, by Global Positioning System.

25. An image data storing system according to claim 22, wherein said site information obtaining means obtains said site information by receiving a service of a site-information provider as said mobile telephone has access to said provider.

26. An image data storing system according to claim 23, wherein said site information obtaining means obtains said site information by receiving a service of a site-information provider as said mobile telephone has access to said provider.

27. An image obtaining apparatus for obtaining image data of a subject, comprising:
(a) storage means for storing the obtained image data of the subject;
(b) means for obtaining site information representing a site at which said image data of the subject has been obtained;
(c) means for obtaining subject information identifying the subject of said image data; and
(d) information adding means for adding both said site information and said subject information to said image data, which is to be stored into said storage means.

28. An image data storing apparatus comprising:
(a) storage means for storing image data of a subject, which image data has been obtained using an image obtaining apparatus;
(b) means for obtaining site information representing a site at which said image data of the subject has been obtained;
(c) means for obtaining subject information identifying the subject of said image data; and
(d) information adding means for adding both said site information and said subject information to said image data, which is to be stored into said storage means.

29. A mobile terminal, for use in an image data storing system, which terminal is to be carried by an individual who is a subject of image data to be obtained by an image obtaining apparatus of the image data storing system, said terminal comprising:
(a) means for holding identification (ID) information of said individual; and
(b) means for transmitting said ID information, which is held by said ID information holding means, to first information adding means of the system for adding said ID information to said image data as subject information.

30. A mobile terminal according to claim 29, further comprising:
means for obtaining a current position of said mobile terminal; and
means for transmitting said current position, which has been obtained by said current terminal-position obtaining means, as site information representing a site at which said image data of the subject has been obtained using said image obtaining apparatus, to second information adding means of the system for adding said site information to said image data.

31. A computer-readable medium in which an image data classification program for classifying a plurality of items of image data is recorded, wherein the plural items of image data have been individually obtained by an image obtaining apparatus, each of the plural items of image data being added thereto regional information relating to a site at which the respective item of image data has been obtained, subject information identifying a subject of the last-named item of image data, and date and time when said respective item of image data is obtained, and wherein said program instructs a computer to function as the following:
(a) means for generating a plurality of classification items in terms of at least one selected from the group consisting of said regional information, said subject information, and said date and time, all of which are added to each of said plural items of image data; and
(b) means for assigning said plural items of image data to the respective classification items, which have been generated by said item generating means, in terms of said at least one selected from the group consisting said regional information, said subject information, and said date and time.

32. A computer-readable medium in which a background information designating program is recorded, wherein said program instructs a computer to function as the following:
(a) means for calculating an image-shooting direction, in which shooting of an image of a subject has been carried out by an image obtaining apparatus of an image data storing system to obtain image data, based on both first site information, representing a site at which the image obtaining apparatus is located and second site information, representing a site at which the subject of said image data is located, when said image data has been obtained; and
(b) means for determining a background subject, which presumably appears in the background of said image data, as background information, based on said image-shooting direction, which has been calculated by said image-shooting-direction calculating means, and said first site information and/or said second site information.

33. A computer-readable medium in which a traveling route designating program is recorded, wherein said program instructs a computer to function as the following:
(a) means for determining auser's traveling route, along which the user has traveled while obtaining a plurality of items of image data at different sites using an image obtaining apparatus, among a plurality of traveling routes, based on both site information representing a site at which an individual item of image data has been obtained and date and time when the last-named individual item of image data has been obtained, both of which have been added to said last-named individual item of image data; and
(b) display control means for performing a control process on a display section, which is associated with the computer, to display said traveling route determined by said traveling route determining means, along with surrounding geographic data in such a manner that said traveling route superimposes over said surrounding geographic data.

34. An image data storing method comprising the steps of:
(a) obtaining image data of a subject by an image obtaining apparatus;
(b) obtaining site information representing a site at which said image data has been obtained;
(c) obtaining subject information identifying the subject of said image data;
(d) adding both said site information and said subject information to said image data; and
(e) storing the resulting image data into a storage device.
